(19) United States
(12) Patent Application Publication
(10) Pub. No.: US 2015/0019190 A1
(43) Pub. Date: Jan. 15, 2015

(54) PROGRAMMABLE CELL MODEL FOR DETERMINING CANCER TREATMENTS

(71) Applicant: Critical Outcome Technologies Inc., London (CA)

(72) Inventor: Wayne R. Danter, London (CA)

(21) Appl. No.: 14/376,912

(22) PCT Filed: Dec. 14, 2012
(86) PCT No.: PCT/CA2012/001152

§ 371 Date: Aug. 6, 2014

Related U.S. Application Data
(60) Provisional application No. 61/576,835, filed on Dec. 16, 2011.

(51) Int. Cl. G06F 19/12; G06F 19/00

(52) U.S. Cl. CPC G06F 19/12; G06F 19/3437
USPC 703/11

(57) ABSTRACT

The disclosure relates to a programmable cancer cell model that may be customized to simulate the effect of gene mutations, for example mutations identified from a particular cancer patient's tissue sample. The simulation may be used to assess the likelihood of a candidate treatment resulting in stable remission for the patient. The model makes use of a fuzzy cognitive map (FCM) simulator that employs a matrix to represent healthy cell signaling relationships and an input disease vector representing one or more genetic mutations. The disease state vector is multiplied by the matrix to produce a stable diseased cell state vector after multiple iterations. A candidate treatment may then be proposed, based upon the diseased cell state vector. After multiple iterations with a treatment vector, the efficacy of the proposed treatment on the patient's particular cancer can be assessed, reducing reliance on the traditional trial and error approach.

### TECHNICAL FIELD

This disclosure relates to computer modeling of biological cells, and more specifically, to computer modeling of human cells, disease pathways and treatments. In particular, the disclosure relates to a programmable cancer cell model that may be customized to simulate the effect of gene mutations, for example mutations identified from a particular cancer patient's genetic profile. The simulation may be used to assess the likelihood of a candidate therapy resulting in stable remission for the patient based on the genetic profile of that patient's cancer.

### BACKGROUND

Cell signaling pathways used by cancerous cells typically lead to upregulation of tumour growth factors and/or downregulation of apoptotic processes meant to cause programmed cell death. Either of these can result in uncontrolled cell growth. Cell signaling pathways are complex and involve multiple intracellular and extracellular proteins, each of which may be implicated in multiple pathways. The result is a multi-facetted web of interactions between particular proteins and their corresponding genes with other proteins in adjacent signaling pathways.

Current and evolving cancer treatments typically focus on inhibition or stimulation of one or more particular protein targets, which can lead to upregulation or downregulation of the cellular processes governed by the signalling pathways that involve those proteins. Since each target has an effect on multiple pathways, it is common to find that, after a period of time, the cancerous tumour adapts and finds new pathways to overcome those being up or down regulated by the treatment. The result is a non-stable remission that requires adjustment of the cancer therapy over time to prevent re-emergence of the cancer. As a result, cancer patients are typically administered a “cocktail” of chemotherapy drugs with different targets, depending upon the type of cancer that the patient has. Determining an appropriate cocktail often involves a trial and error approach, guided by a historical or statistical “best practices” that work in a certain percentage of cases, but are not universally effective for all patients exhibiting cancer of a particular type.

Due to advances in scientific understanding of cancer genetics and genetic profiling, it is now possible to obtain a reasonably accurate genetic profile for a particular patient's tumour from tissue or blood samples. The oncologist can use the genetic profile of the tumour to determine which gene mutations are likely to be responsible for the patient's cancer, which can serve as a guide in suggesting an appropriate cocktail for treatment. However, determining whether or not the cocktail leads to stable remission still involves a trial and error approach, which can sometimes be fatal to the patient.

### SUMMARY

It would therefore be desirable to have a method of predicting in advance of treatment the potential for stable remission afforded by a particular treatment option or cocktail of chemotherapy drugs. It would be desirable for such a method to be capable of taking into account a particular patient's genetic profile. It would be desirable for such a method to be implemented on a computing device, such as a laptop, PDA, tablet, mobile phone or the like. To ensure speed and accuracy, it would be desirable for the method to be implemented by a server over a computer network with input and output directed from/to the computing device.

In one aspect, there is provided a computer-implemented method of modeling a cell state, the method comprising: modeling at least a portion of a healthy cell using a cell model based on a fuzzy cognitive map, the cell model defining relationships between factors, the cell model being stored in at least a computer; applying a disease state vector to the cell model, the disease state vector configured to represent a disease affecting the cell; obtaining a new diseased cell state vector of the cell model based on the applied disease state vector; and, providing a first output indicative of the established diseased cell state vector of the cell model.

In another aspect, there is provided the above computer implemented method, further comprising: modifying the diseased cell state vector to obtain a treatment state vector configured to represent a proposed treatment for the established disease; applying the treatment state vector to the cell model; obtaining a treated cell state vector from the cell model based on the applied treatment state vector; and, providing a second output indicative of the established treated cell state vector of the cell model.

In yet another aspect, there is provided a system for modeling a cell state, the system comprising a server connected to a network and configured to communicate with a plurality of remote devices, the server further configured to: store a cell model of at least a portion of a healthy cell, the cell model based on a fuzzy cognitive map, the cell model defining relationships between factors; receive an indication of a disease state vector from a remote device of the plurality of remote devices via the network; apply the disease state vector to the cell model, the disease state vector representing a disease affecting the cell; obtain a diseased cell state vector of the cell model based on the applied disease state vector; provide a first output indicative of the diseased cell state vector of the cell model to the remote device via the network; receive an indication of a treatment state vector from the remote device via the network; modify the diseased cell state vector to obtain the treatment state vector, the treatment state vector representing a proposed treatment for the disease; apply the treatment state vector to the cell model; obtain a treated cell state vector of the cell model based on the applied treatment state vector; and, provide a second output indicative of the treated cell state vector of the cell model to the remote device via the network, the second output being indicative of an efficacy of the proposed treatment.

In any of the aspects above, the cell model can include factors representing cell signaling pathways.

Further aspects of the invention will be described hereinafter.

### BRIEF DESCRIPTION OF THE DRAWINGS

The drawings illustrate, by way of example only, embodiments of the present disclosure.

FIG. 1 is a causal diagram form of an example fuzzy cognitive map for a cell.

FIG. 2 is a matrix representation of the example fuzzy cognitive map.

FIG. 3 shows a state vector of an example state for the fuzzy cognitive map.

FIG. 4 shows an iterative formula involving vector matrix multiplication for obtaining a new state vector.

FIG. 5 shows a sample calculation of a new state vector.

FIG. 6 is a partial table of current states and new states.

FIG. 7 is another partial table of current states and new states.

FIG. 8 is a flowchart of an example method of modeling a cell.

FIG. 9 is diagram of an example system for modeling a cell.

FIG. 10 is a diagram of an example input interface for generating a disease state vector.

FIG. 11 is a diagram of an example output interface.

FIG. 12 is a diagram of an example input interface for generating a treatment state vector.

### DETAILED DESCRIPTION

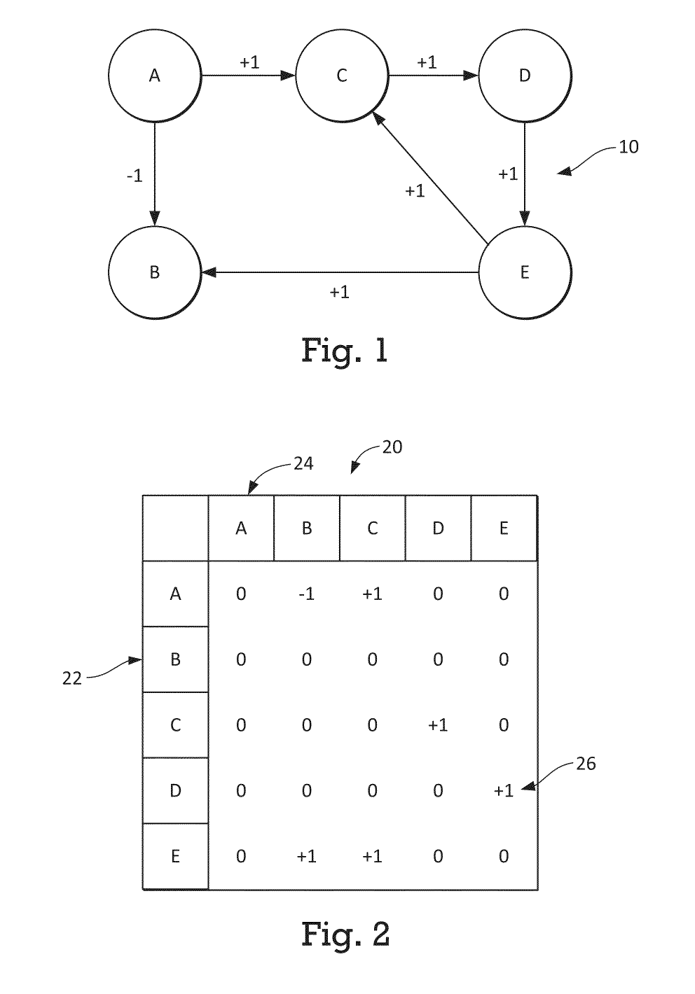

FIG. 1 shows a causal diagram representation of an example fuzzy cognitive map (FCM) 10. As will be discussed in this disclosure, a FCM, such as the FCM 10, can be used to computationally model biological cell states.

The example FCM 10 comprises factors A-E, represented by circles, and relationships between the factors, represented by arrows. In this example, the factors A-E represent the expression of proteins (i.e., first through fifth proteins) in a biological system, and specifically, the expression of proteins involved in intercellular or intracellular signaling pathways. Since protein expression is caused by genes, the factors A-E also represent the genes (i.e., first through fifth genes) corresponding to the proteins.

The FCM 10 represents a portion of a healthy cell's signaling system, which allows the cell to carry out basic cellular activities as well as coordinate actions among a group of cells. In this example, the FCM 10 is a trivalent-state FCM. The factors A-E numerically represent whether a protein is over expressed, normally expressed, or suppressed, which are respectively indicated by the values +1, 0, and −1. The arrows connecting the factors represent causal relationships among the factors, and can take values of +1, 0, and −1, with the arrow direction indicating the direction of cause to effect. A relationship value of +1 means that the factor at the origin of the arrow stimulates expression of the factor at the tip of the arrow. A relationship value of 0 means there is no relationship or a neutral relationship between the factors (and the arrow is omitted). And, a relationship value of −1 signifies that the originating factor suppresses or inhibits the factor shown at the arrowhead.

In another example, a pentavalent-state FCM is used, in which states and/or relationships can be assigned the values −1.0, −0.5, 0.0, +0.5, and +1.0. In still another example, a continuous-state FCM is used. In a continuous-state FCM, states and relationships can take a continuous range of floating-point values.

Factors that have only outgoing arrows may be referred to as transmitters (i.e., factor A), factors that have both incoming and outgoing arrows may be referred to as ordinary (i.e., factors C, D, and E), and factors that have only incoming arrows may be referred to as receivers (i.e., factor B).

In terms of proteins, protein A when expressed causes protein C to be expressed by way of one or more cell signaling pathways. It should be noted that cell signaling pathways are complex and have been simplified by the FCM 10, which in fact is one of the benefits of using the FCM 10. In the biological system modeled, protein A may interact with a receptor on a cell that begins a chain of molecule-scale chemical reactions that results in protein C being produced. Likewise, when protein A is expressed, protein B is suppressed. For example, protein B may be consumed during the reaction that produces protein C. These are merely illustrative examples.

The FCM 10 can be established based on empirical data or theories regarding the causal relationships between the proteins A-E. If a causal relationship is currently unknown, it can be given the value of 0 (no arrow). As new information is discovered the causal diagram and relationship matrix are updated to reflect the new knowledge. In this way the cell signaling model is continually evolving.

Referring to FIG. 2, the FCM 10 and the corresponding cell can then be described as a matrix 20. The rows 22 of the matrix 20 indicate the effects of each of the proteins A-E on expression of each of the proteins A-E as arranged in columns 24. Each element 26 of the matrix 20 can thus take a value of +1, 0, or −1. For instance, the top-most row shows that protein A suppresses protein B (−1), promotes expression of protein C (+1), and has no appreciable or known effect on proteins D and E. Likewise, referring to the fourth row, protein D only causes expression of protein E (+1).

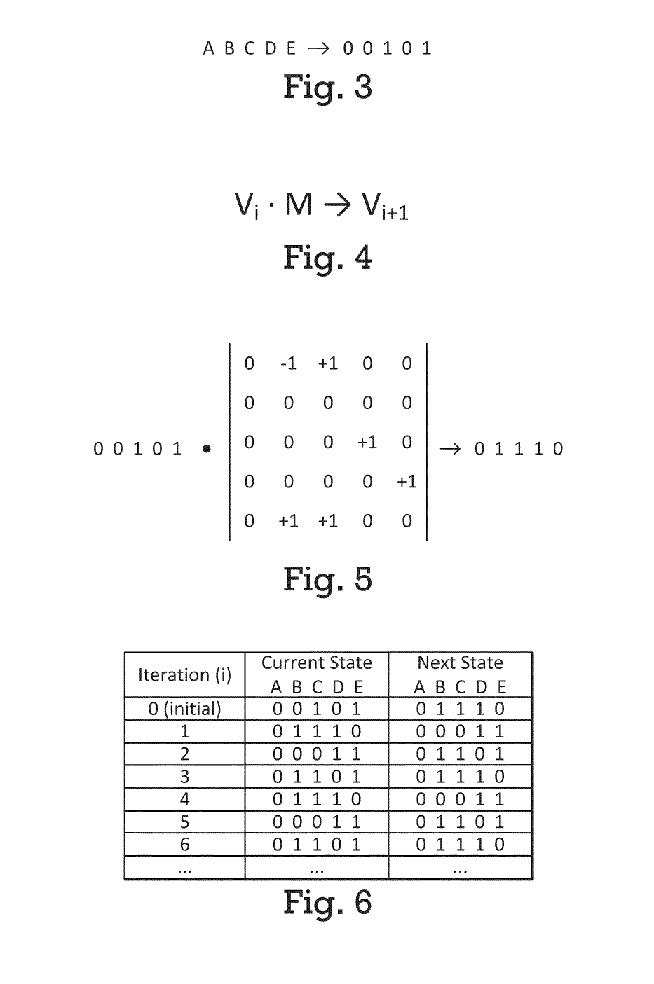

A state of the FCM 10 at any given time can be defined by a vector, as shown in FIG. 3. In this example, the vector includes five values, one for each of the proteins A-E. As mentioned, the values can be +1, 0, or −1, depending on whether the respective protein is expressed, not expressed, or suppressed.

For any current state of the cell being modeled, the next state can be obtained by multiplying the current state by the matrix 20 that defines the relationships among the proteins A-E. The equation of FIG. 4 illustrates this with a state index of i. For a given state i, the next state i+1 can be readily obtained. The next state i+1 can then be multiplied by the matrix 20 to arrive at a future state i+2, and so on. A series of states can be obtained in an iterative manner.

In a first numerical example, suppose that the proteins C and E are initially expressed. This corresponds to the state vector shown in FIG. 3. Biologically, this may mean that genes C and E have produced a certain amount of proteins C and E during a particular stage in the modeled cell's life.

This initial state can be applied as a disturbance to the cell model by multiplying the matrix 20 by the state vector. For each column of the matrix, each element of the vector is multiplied by the corresponding element in the column. The results of the multiplications are then added to obtain a value for the corresponding column of a result vector. This is done for all columns of the matrix 20, which results in a new state vector of the same dimension as the initial state vector. For example, the second element (protein B) of the resultant state vector takes a value of 0*(−1)+0*0+1*0+0*0+1*1=1. Similarly, protein C (third element) takes a value of 0*1+0*0+1*0+0*0+1*1=1. Likewise, proteins A, D, and E take respective values of 0, 1, and 0. If the multiplication process results in a value greater than 1 or less than −1, then such a value is thresholded to 1 or −1, respectively, to keep the resulting protein states congruent with the original model. When discrete non-integer states are used, such as in a pentavalent-state model, thresholding can include rounding to the nearest state (i.e., 0.6 would be rounded to 0.5, −0.79 would be rounded to −1, and so on). Thresholding can be omitted in continuous-state models. Thresholding may also be known as squashing.

Referring back to FIG. 1, it can be seen that this example result naturally follows the initial state. Protein C caused protein D to be expressed, and protein E caused both proteins C and B to be expressed. A new state for the cell model has been reached.

The new state can then be fed back into the relationship matrix 20 to obtain a subsequent new state. Multiplying the state vector representing the expression of proteins B, C, and D and the absence of proteins A and E results in a cell state illustrated by the third current state vector in FIG. 6 (see iteration 2), that is, the expression of only proteins D and E. Again, this naturally follows the causal relationships set up at the outset, as shown by the FCM 10 in FIG. 1. FIG. 6 shows additional iterations, and it can be seen that a cyclic pattern quickly emerges. The cyclic pattern can be represented by the cell states at iterations 1 through 3.

Biologically, this cyclic pattern may correspond to the functioning of a healthy cell. Supposing that protein E is essential to cellular division, the model cell undergoes two cycles of division followed by one cycle where the cell does not divide. This may be representative of healthy tissue growth.

The table of FIG. 6 can be provided as direct output of a computer programmed to perform the above operations. In another example, the cyclic pattern described can be stored and the computer can simply output an indication that the cell is healthy.

Another aspect of the FCM 10 is that factors can be locked to particular values. This may be known as enforcing a policy on the FCM 10. For example, factor C can be set to always take the value of 1, regardless of the outcome of the state vector-matrix multiplication. In the biological cell model, this may correspond to a mutation in gene C that causes protein C to be expressed continually, rather than just initially as in the previous numerical example. Such a mutation may correspond to a disease.

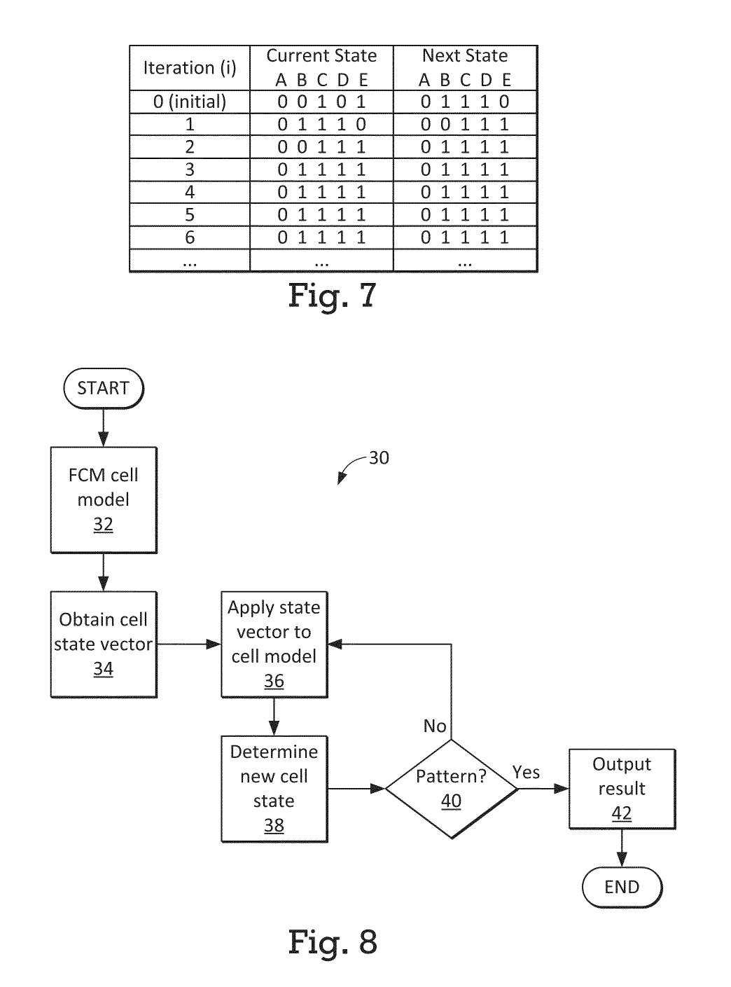

Using the same starting conditions as above (i.e., only proteins C and E expressed), FIG. 7 numerically illustrates what happens when gene C suffers from a mutation that results in the continual expression of protein C, while protein E is expressed normally (as an initial disturbance only). It can be seen that the next state of iteration 1 has protein C being expressed. This is not the calculated result of the vector-matrix multiplication (as shown by the same state in FIG. 6 where protein C is not expressed), but rather protein C is forced to take the value of 1 to signify the enforced policy of its continual expression. Accordingly, all states shown in FIG. 7 have protein C expressed.

One consequence of this policy is that the cell model quickly converges to a stable state of proteins B, C, D, and E being expressed at every state. Supposing still that protein E is essential to cell division, and further promotes cell division, the result may be a cell that divides more than normal. Since the mutation of gene C is copied to the cell's progeny, a tissue formed by the modeled cells may grow faster than that formed by healthy cells (recalling that in the example of FIG. 6, protein E was only expressed during two-thirds of the states). Consequently, FIG. 7 may represent behavior of a cancerous cell. Moreover, the policy of holding factor C to a value of 1 may represent the genetic signature of this particular cancer. The stabilized vector of proteins B, C, D, and E being expressed at every state may be referred to as a diseased cell state vector.

Referring back to FIG. 1, the FCM 10 can also use compound factors. A compound factor does not affect the underlying structure of the FCM 10, but rather is a kind of shorthand to facilitate input vector construction and output interpretation. For input vector construction, a compound factor can include values that are to be set or locked as policy for several factors. For example, a compound factor Q may include values of 1 and −1 for the proteins A and E, respectively. Thus, if the factor Q is locked as a policy with a value of 1, the values of A and E are respectively held at 1 and −1. As for output interpretation, the factor Q, when not locked as a policy, takes an output value of 1 at any iteration where the values of A and E are respectively 1 and −1. In this way, compound factors can represent larger concepts, such as a general possibility of cancer remission or programmed cell death (apoptosis), that are affected by a number of factors.

The FCM 10 thus models a gene mutation based disease affecting a previously healthy cell. And as will be discussed further below, the above process can also be used to model the effects of treatments on the modeled cell.

The above-described process can be structured into a computer-implemented method 30, as illustrated by the flowchart of FIG. 8.

After being started, the method 30 at step 32 models a FCM for at least a portion of a healthy cell, such as one or more healthy cell signaling pathways. In one example, all known pathways of a cell are modeled, and such a model may represent many hundreds of proteins amounting to thousands or more protein-to-protein relationships. In another example, only a select subset of pathways are modeled, and an entire cell may be modeled over several models, where any model needed can be selected. The cell model is stored in at least a computer (e.g., a server or a bank of servers) as, for example, a data structure representing a matrix of expressive relationships among proteins (e.g., see matrix 20 of FIG. 2). Step 32 can thus include one or more of loading a particular cell model, receiving input or selection of a cell model, or generating or modifying a cell model based on inputted or received empirical data.

In one example of step 32, one or more cell models are stored at a server and loaded into active memory of the server when required. The cell models are regularly updated by an operator as new peer reviewed data obtained from medical publications or other sources becomes available.

Next, a cell state vector is obtained at step 34. The cell state vector can include any combination of a disturbance to a protein expression or suppression or a locked policy of protein expression, non-expression, or suppression. Recall the example of FIG. 7, where protein C was held as a policy of continual expression due to genetic mutation and protein E was applied once at the start as a normal and healthy disturbance to the model. The cell state vector can represent a disease, such as a specific cancer, that results from and propagates the abnormal expression of certain proteins. The cell state vector can represent a treatment. The state vector can be obtained from the memory of the same server that stores the cell model, from a different server, from an input device connected to the server, or from a remote device configured to communicate with the server.

In one example, a disease state vector is generated based on data or other indication received at a remote device operated by a doctor or other healthcare professional who has inputted tissue biopsy results or a genetic profile of a tumor. The disease state vector can then be generated at a server, or generated at the remote device and then sent to the sever.

In another example, a treatment state vector is generated based on data or other indication received at a remote device operated by a doctor or other healthcare professional who has inputted a proposed treatment. The treatment state vector can then be generated at a server, or generated at the remote device and then sent to the sever.

At step 36, the server multiplies the cell model relationship matrix by the state vector. Initially, the state vector obtained at step 34 is used. During subsequent iterations, the resulting new state vector is used, after thresholding and application of any enforced policies. This multiplication can be programmed in the server based on the principles discussed above (see FIGS. 4 and 5).

At step 38, a vector describing the new cell state is determined. The results of this step are stored in memory to reference when identifying cyclic or repetitive patterns indicative of a stable-state functioning of the cell. For complex cell models it may be prudent to store cell states in non-volatile memory, such as a hard drive of the server.

Next, at step 40, the method determines whether a stable pattern exists in the cell states. A pattern recognition algorithm, can be used to identify cyclic patterns (e.g., that of FIG. 6). An example pattern recognition tests for repeated states over a range of states. Repetitive patterns (see FIG. 7) can be tested for simply by comparing two adjacent cell states.

If a stable pattern has not been detected, then step 36 is repeated by multiplying the cell state vector determined in step 38 by the cell model matrix to obtain a new cell state vector. The method 30 iterates through steps 36, 38, 40 over a series of cell state vectors until stabilization of the cell model is achieved.

Once a stable pattern of cell states has been detected or a cycle limit has been reached (as an escape for endless loops), the method 30 proceeds to output a result at step 42. The output can include the actual cell state or pattern of cell states. Additionally or alternatively, the result can be indicative of the cell state or pattern of cell states.

When a disease state vector is used in step 34, the output is a first output indicative of the resulting diseased state of the cell.

In one example, the first output is limited to proteins known to be markers for certain forms of cancer. Referring to the previous numerical example and recalling that protein E related to cellular division. If protein E is expressed as in the cyclic pattern of FIG. 6, then the first output can comprise indicative text such as “Marker Protein E is Normal”. On the other hand, if protein E is found to be expressed continually (see FIG. 7), then the first output can comprise indicative text such as “Marker Protein E is Abnormal”. The indications can be color-coded, with red indicating a cancer marker, yellow indicating a possible cancer marker or other disease marker, and green indicating a healthy marker. Any form of indication readily understood by healthcare professionals can be used.

To model a treatment, the method 30 can be applied initially using a disease state vector. The first output at step 42 is thus still a diseased cell state vector. The diseased cell state vector can then be modified to obtain a treatment state vector, which can be used in a second application of the method 30, at step 34, to obtain a second output, namely, a treated cell state vector indicative of an efficacy of the proposed treatment. That is, if the treated cell state vector is a healthy cell state, then the proposed treatment may be effective.

The treatment state vector can be obtained from the diseased cell state vector by applying a policy representative of, for example, a drug, radiation therapy, immunotherapy, or hormonal therapy. For instance, if a drug is known to inhibit expression of protein A, then the treatment state vector based on the diseased cell state vector obtained in FIG. 7 (i.e., 0 1 1 1 1) is −1 1 1 1 1, where the inhibition of protein A (i.e., −1) is held for every iteration. Modification of a diseased cell state vector to obtain a treatment state vector can include changing any of the protein values and enforcing a policy on any of the protein values. An indication of a proposed treatment can thus be one or more protein values or policies to be applied to the diseased cell state vector. Then, the result of applying the treatment state vector to the cell model using the method 30 can be obtained in the same way as described above and provided as a second output at step 42.

Treatments can be combined by modifying the diseased cell state vector as above to reflect multiple treatments. An example of a combined treatment state vector based on the diseased cell state vector obtained in FIG. 7 (i.e., 0 1 1 1 1) is −1 1 −1 1 1, where the inhibition of proteins A and C (i.e., −1) are affected by two different treatments and are accordingly locked for every iteration.

Treatments can be started, stopped, or combined during the iteration process. For example, it may be observed that an initial treatment does not produce the desired result, and thus an additional treatment can be applied by modifying the current cell state vector by changing a value or by applying a new policy. Treatments can be stopped at any time during the simulation in the same manner. With reference to the same example, the treatment of inhibiting only protein A may be discontinued and the treatment of inhibiting protein C may be started by unlocking the value of −1 previously held as a policy for protein A and locking protein C to a value of −1 for subsequent iterations.

In one example, the second output is limited to proteins known to be markers for certain forms of cancer, as with the first output. In another example, the treated cell state vector is compared to a known healthy cell state, and the second output simply indicates success or failure.

It should be understood that any of the steps of the method 30 can be aggregated or further separated, and the above is merely one example.

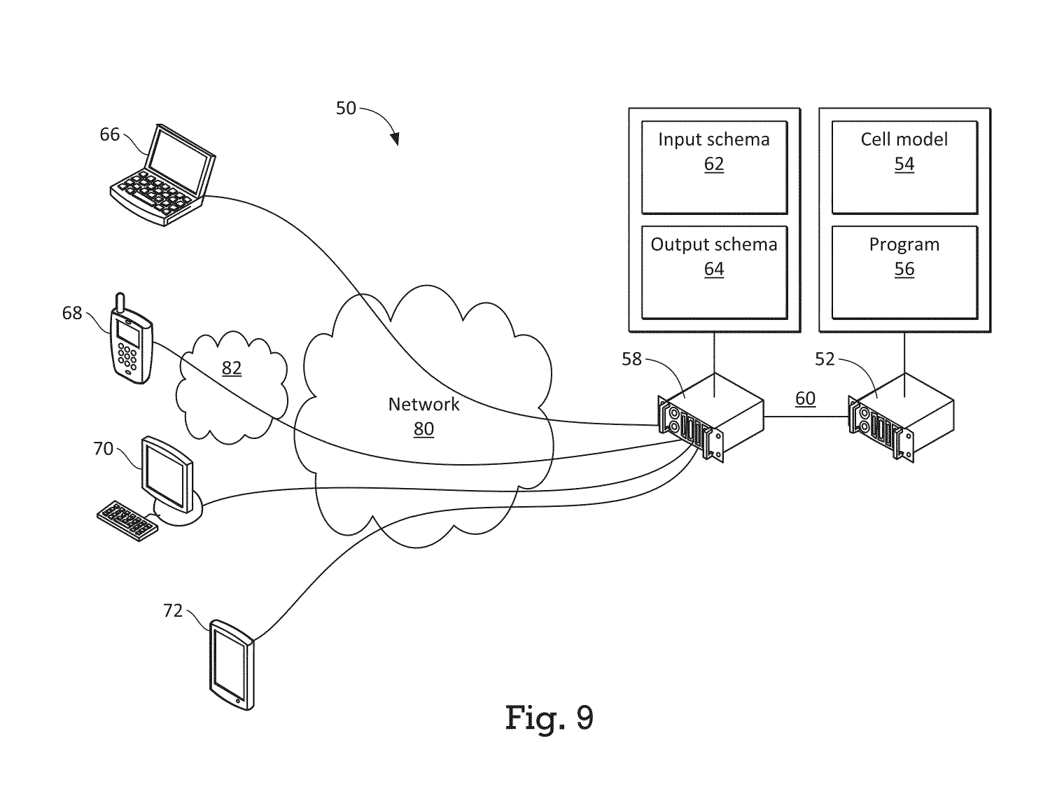

FIG. 9 shows a system 50 that implements the above-described method 30.

A data server 52, or several data servers, stores one or more cell models 54 as well as a program 56 to generate state vectors based on received tissue biopsy data or tumor profiles or proposed treatments, apply a state vector to a cell model, determine a resulting state or cycle of states, and generate output of such.

The cell model 54 can be of the kind described elsewhere herein (e.g., matrix 20) and can be stored in any appropriate data structure, such as a database, an array or set of arrays, a data file, or similar. The program 56 can embody any of the methods described herein. The program 56 can be written in any suitable language, such as a member of the C family of languages, Visual Basic™, or the like. The program 56 can include one or more of a standalone executable program, a subroutine, a function, a module, a class, an object, or another programmatic entity. The data server 52 is a computer that includes hardware for executing the program 56, such as a central-processing unit (CPU), memory (e.g., RAM/ROM), and non-volatile storage (e.g., hard drive). The data server 52 can be a computer of the kind that is readily commercially available.

Cell state vectors can be stored in the data server 52 and can be indexed by a unique ID, such as a patient ID. An indication of a proposed treatment can reference the patient ID so that the appropriate diseased cell state vector can be retrieved and then modified to obtain the proposed treatment vector.

A frontend server 58, or several frontend servers, is coupled to the data server 52 via a network 60, such as a local-area network (LAN), a wide-area network (WAN), or the Internet. From a hardware perspective, the frontend server 58 can be similar to or the same as the data server 52.

The frontend server stores input schema 62 and output schema 64. The input schema 62 is configured to receive data or indication of a state vector, such as a disease state vector or a treatment state vector, from a remote device and provide such to the data server 52. The output schema 64 is configured to format output provided by the data server 52 for presentation on the remote device.

The input and output schemas 62, 64 can each be expressed in extensible markup language (XML), hypertext markup language (HTML), another structured definition language, or in any other suitable way. In one example, the input and output schemas 62, 64 comprise Web pages expressed in HTML and cascading style sheets (CSS), and can include client-executable code such as JavaScript™ or Ajax code. In another example, the input and output schemas 62, 64 are expressed in XML that is interpretable by a client-side application.

In another example, the data server 52 and frontend server 58 are processes running on the same physical server. In yet another example, the data server 52 and frontend server 58 are part of the same program running on one or more physical servers or on a local computer.

Remote devices can include any of a notebook computer 66, a smart phone 68, a desktop computer 70, a tablet computer 72, and other similar devices. Any of the remote devices 66, 68, 70, 72 and other similar devices can be considered a computer. In this example, remote devices 66, 68, 70, 72 communicate with the frontend server 58 via a network 80, such as a LAN, WAN, or the Internet. The smart phone 68 is also shown as communicating through a wireless carrier network 82. The remote devices 66, 68, and 70 include Web browsers to interact with Web pages embodying the input and output schemas 62, 64. On the other hand, the tablet computer 72 includes a purpose-built client application configured to operate on XML or other code embodying the input and output schemas 62, 64.

The makeup of the network 80 can be chosen to reach physicians or other individuals around the world. Accordingly, the network 80 can include the Internet, which may deliver information via the World Wide Web. The network 80 can additionally or alternatively include a satellite network, which may be useful for serving remote locations.

In other examples, the devices 66, 68, 70, 72 communicate with the frontend server in manners different from those described above.

Cell state vectors, such as a disease state vector, a diseased cell state vector, a treatment state vector, and a treated cell state vector can be referenced in a variety of ways by the devices 66-72 and the servers 52, 58. For example, an indication of a vector rather than the vector itself can be communicated, stored, outputted, or received as input. Such indications can include differences from other vectors, indications of proteins expressed or not expressed as compared to another vector, aliases of vectors (e.g., names of common treatments), and so on. On the other hand, the entire vector itself can be referenced.

A purpose-built client application configured to operate on XML-based input and output schemas 62, 64 can be written in any programming language, such as the languages described above, using known techniques.

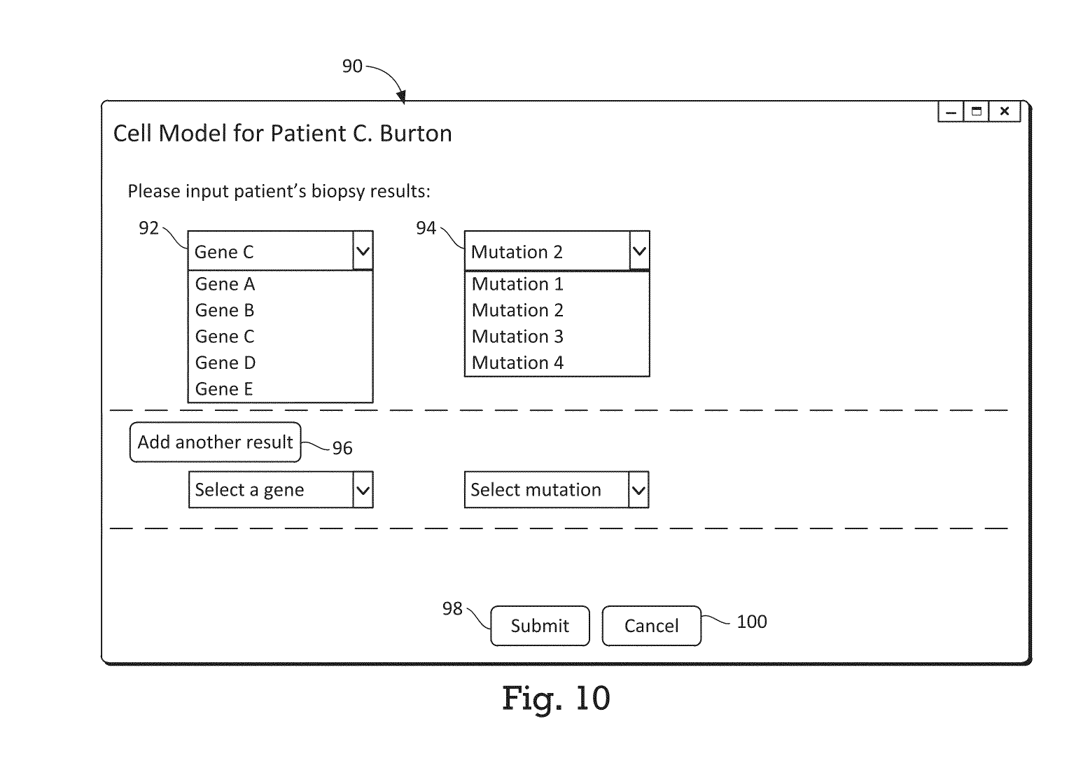

FIG. 10 shows an example of an input interface 90. The input interface 90 can be provided on the remote devices 66, 68, 70, 72 according to the input schema 62. The input interface 90 can be defined by the input schema 62 and interpreted and rendered by the remote devices 66, 68, 70, 72.

The input interface 90, or form, includes an input element 92, which in this example is a dropdown list control, for selecting a portion of a patient's biopsy results. In accordance with the example above, a specific gene can be selected.

Another input element 94, such as another dropdown list control, is provided as corresponding to the input element 92. The input element 94 is used to select a mutation affecting the selected gene.

A third input element, button 96, is provided to insert another pair of input elements 92, 94 for selection of another gene mutation. The form 90 can grow to accommodate as many pairs of input elements 92, 94 as required.

Once all gene mutations have been entered, the input element 98, a submit button, can be pressed to submit the biopsy results to the frontend server 58, which passes the inputted information to the data server 52. Another input element, such as a button 100, can be provided to cancel input and clear the form or return to a previously displayed interface.

The frontend server 58 can convert the received input into a format for consumption by the data server 52 or can simply pass the input as received to the data server 52.

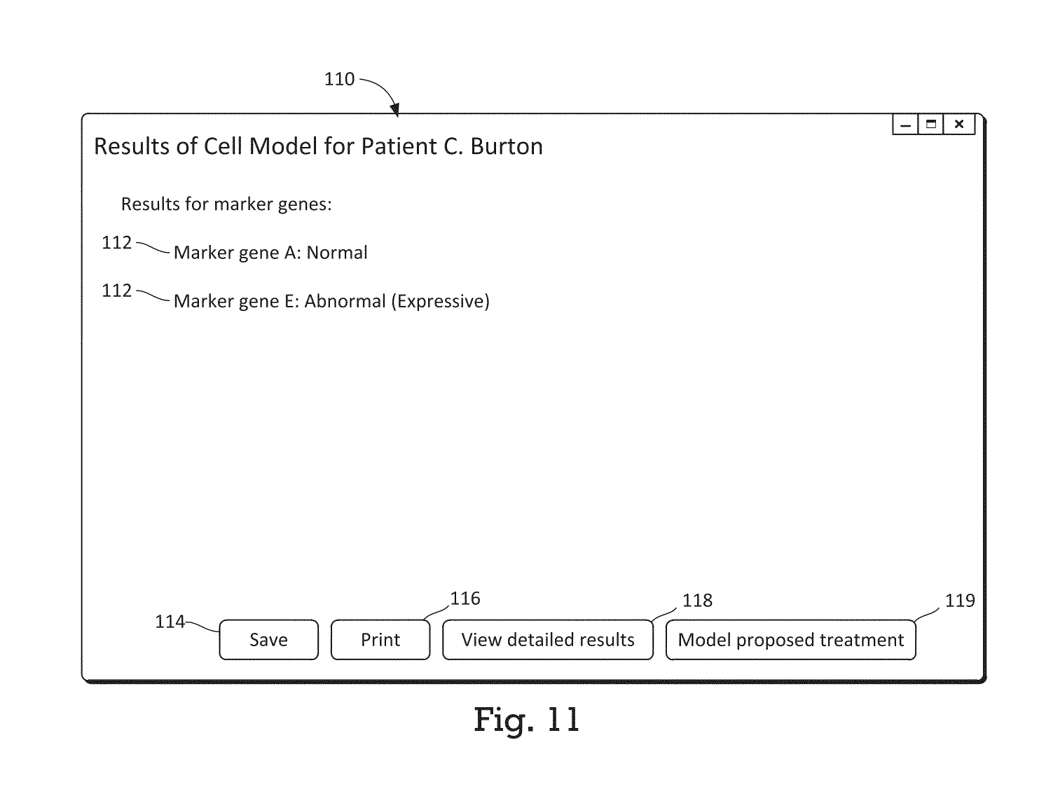

After performance of one of the methods described herein, the data server 52 responds with a first output, which the frontend server 58 provides over the network 80 to the requesting remote device 66, 68, 70, 72 according to the output schema 64. FIG. 11 shows an output interface 110 that can be defined by the output schema 64 and rendered by the remote device 66, 68, 70, 72.

Output elements, which in this example include text strings 112, indicate the results of the cell model for specific marker genes. The text strings 112 can be color-coded or highlighted in other ways.

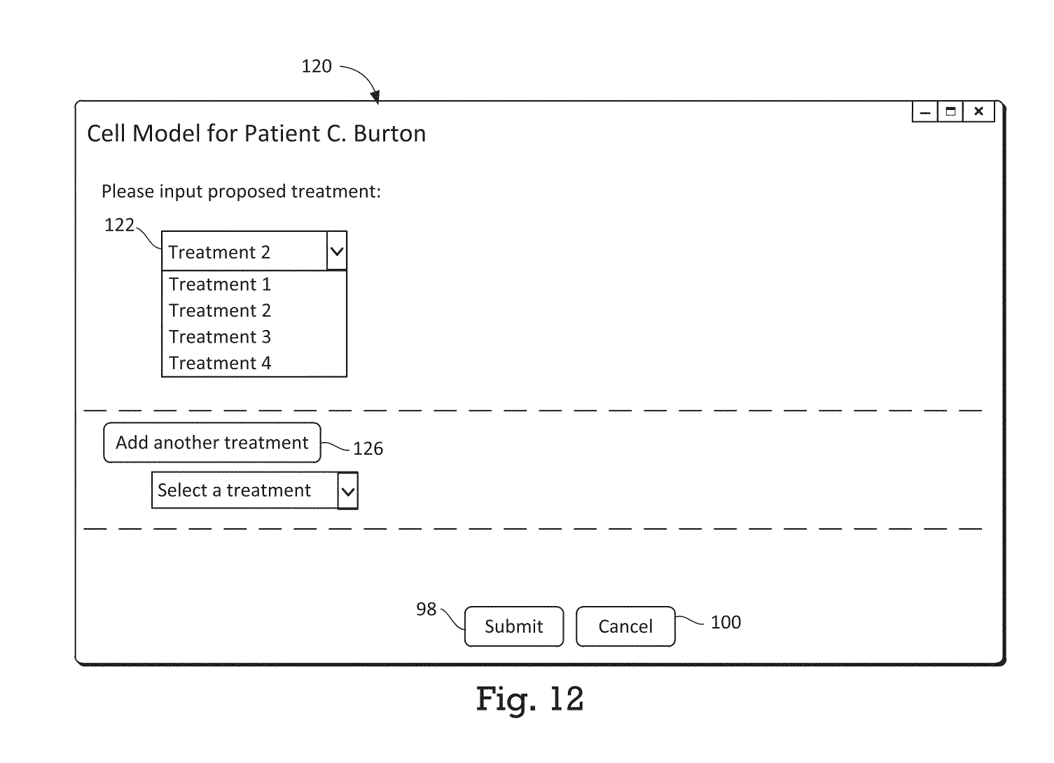

A set of three input elements, or buttons, 114, 116, 118, are included to allow saving and printing the results, as well as viewing details of the results and proposing a treatment. Pressing the button 118 submits a request to the servers 58, 52 to provide a more detailed state of the cell model. Pressing button 119 causes the input interface 120 of FIG. 12 to be displayed.

FIG. 12 shows an example of the input interface 120. The input interface 120 can be provided on the remote devices 66, 68, 70, 72 according to the input schema 62. The input interface 120 can be defined by the input schema 62 and interpreted and rendered by the remote devices 66, 68, 70, 72.

The input interface 120, or form, includes an input element 122, which in this example is a dropdown list control, for selecting a portion of proposed treatment for a patient.

Another input element, button 126, is provided to insert another input element 122, 94 for selection of another proposed treatment. The form 120 can grow to accommodate as many input elements 122 as required.

Once all proposed treatments have been entered, the input element 98, a submit button, can be pressed to submit the proposed treatments to the frontend server 58, which passes the inputted information to the data server 52. Another input element, such as a button 100, can be provided to cancel input and clear the form or return to a previously displayed interface.

The frontend server 58 can convert the received input into a format for consumption by the data server 52 or can simply pass the input as received to the data server 52.

After performance of one of the methods described herein, the data server 52 responds with a second output indicative of the cell state, such as that shown in FIG. 11. The second output can indicate to the healthcare professional the effect of the treatment on the model, which may include an output of the treated cell state vector (or the genes represented by the vector values) for assessment by the professional or a simplified interpretation stating whether the proposed treatment was successful or not. If the proposed treatment was not successful (for example, did not result in a stable remission indicated by a pattern of repeated values for the treated cell state vector), the healthcare professional may be given the option to assess another proposed treatment by returning to FIG. 12. In this manner, several potential treatment options may be assessed using the model, without resorting to trial and error methods that could potentially prove fatal for the patient.

An additional feature may optionally be provided with the system and method whereby a proposed treatment is suggested by the data server 52. In one example, the proposed treatment may be provided based on a database of clinically accepted best practices for the treatment of cancers of known type or known genetic profile. In this case, FIG. 12 may include certain pre-selected suggested treatment options that may either be accepted or adjusted by the healthcare professional prior to clicking the submit button 98. In another example, the server 52 may automatically assess several proposed treatment options, based on the genetic profile of the patient's tumour, and provide a second output corresponding to each proposed treatment option for comparative assessment by the healthcare professional. In yet another example, the second output may be used by the server 52 to iteratively modify the proposed treatment option, based on the need to counteract any persistent abnormal gene expression through treatment using a chemotherapy targeting that gene. In this manner, potential treatment options may be assessed by the server 52 so that the final output comprises both an optimal suggested treatment and an indication of the treatment effect.

Another aspect of the data server 52 may be to provide a database of tumor gene profiles in conjunction with in vivo results, either obtained in the laboratory or from real live patient outcomes. The in vivo results may be obtained in the laboratory using gene profiles obtained from patient tumor biopsies to create rodent xenografts for in vivo testing. In one aspect, the treatment option being tested may be suggested by the FCM model. In other instances, there may be insufficient data available in the medical literature for the model to make a prediction based on the patient gene profile. In this case, xenografts may be created in order to attempt a proposed treatment technique experimentally and the outcome of that treatment may be uploaded to the database. In this way, the data server 52 contains not only data obtained from the medical literature, but also de novo data obtained based on real patient tumor biopsies. This enhanced data set within the data server 52 may be used to further improve the outcome of the FCM model in terms of predicting a proposed treatment option for a given gene profile. In addition, a physician who obtains real patient results, once the patient is treated with a particular treatment option, may provide those results to the data server 52 for augmenting the database. This technique can be used to further enhance the accuracy of predictions from the FCM model. Another aspect of the data server 52 is the cross-referencing of in vivo results, whether from xenografts or patients, with model predictions. This provides further validation and comfort for physicians to propose a certain treatment technique based upon the obtained patient gene profile, since the greater the number of validation points for the suggested treatment technique, the more likely that treatment technique is to succeed. Loading of patient results by physicians that are geographically distributed, perhaps even on a global basis, may be facilitated by providing certain access rights to certain physicians to augment the database remotely, according to a predetermined data format.

One benefit of the above-described techniques is that a therapeutic intervention can be personalized and optimized based on the genetic mutation profile of an individual's cancer, thereby improving the probability of disease remission while reducing the increased health risk associated with ineffective therapies.

Another use of the techniques described herein is identifying research targets by selecting treatment vectors that correspond to hypothetical treatments, such as treatments that have yet to be developed or treatments that lack sufficient evidence to use in actual patients. The potential efficacy of treatments that are still under clinic trial can also be tested.

The system and method will now be further described with reference to the following examples, showing the efficacy of the system and method in assessing treatment options for a variety of cancers with specific genetic profiles.

### EXAMPLES

Referencing published medical literature and using the methodology described above, a cell model matrix similar to the matrix 20 was constructed to simulate a human cell, as well as the effects of cancer inducing gene mutations and their possible treatments on the cell. The cell model matrix includes rows and corresponding columns that define relationships for various proteins and cell signaling pathways for the cell. Compound factors were also used as a way of combining individual factors to simplify locking policy to multiple factors and interpreting output. The factors and relationships were identified from published medical literature including cell pathway diagrams and information available from KEGG: Kyoto Encyclopedia of Genes and Genomes (http://www.genome.jp/kegg/), Cell Signaling Technology® (http://www.cellsignal.com/index.jsp), which is incorporated herein by reference, among other readily assessable publicly available sources. A partial list of such sources is provided below with reference to various relationships used to form the cell model matrix. All of these sources are incorporated herein by reference.

Representative Sources:

Pathways in Cancer, http://www.genome.jp/kegg-bin/show_pathway?hsa05200

Wnt Signaling Pathway, http://www.genome.jp/kegg-bin/show_pathway?hsa04310

JAK-STAT Signaling Pathway, http://www.genome.jp/kegg-bin/show_pathway?hsa04630

ERBB Signaling Pathway, http://www.genome.jp/kegg-bin/show_pathway?hsa04012

Calcium Signaling Pathway, http://www.genome.jp/kegg-bin/show_pathway?hsa04020

MAPK Signaling Pathway, http://www.genome.jp/kegg-bin/show_pathway?hsa04010

PPAR Signaling Pathway, http://www.genome.jp/kegg-bin/show_pathway?hsa03320

P53 Signaling Pathway, http://www.genome.jp/kegg-bin/show_pathway?hsa04115

TGF-beta Signaling Pathway, http://www.genome.jp/kegg-bin/show_pathway?hsa04350

VEGF Signaling Pathway, http://www.genome.jp/kegg-bin/show_pathway?hsa04370

mTOR Signaling Pathway, http://www.genome.jp/kegg-bin/show_pathway?hsa04150

Cytokine-Cytokine Receptor Signaling, http://www.genome.jp/kegg-bin/show_pathway?hsa04060

Apoptosis, http://www.genome.jp/kegg-bin/show_pathway?hsa04210

Colorectal Cancer Mutations and Signaling, http://www.genome.jp/kegg-bin/show_pathway?hsa05210

Pancreatic Cancer Mutations and Signaling, http://www.genome.jp/kegg-bin/show_pathway?hsa05212

Glioblastoma Mutations and Signaling, http://www.genome.jp/kegg-bin/show_pathway?hsa05214

Thyroid Cancer Mutations and Signaling, http://www.genome.jp/kegg-bin/show_pathway?hsa05216

Acute Myeloid Leukemia Mutations and Signaling, http://www.genome.jp/kegg-bin/show_pathway?hsa05221

Chronic Myeloid Leukemia Mutations and Signaling, http://www.genome.jp/kegg-bin/show_pathway?hsa05220

Basal Cell Cancer Mutations and Signaling, http://www.genome.jp/kegg-bin/show_pathway?hsa05217

Hedgehog Signaling Pathway, http://www.genome.jp/kegg-bin/show_pathway?hsa04340

Multiple Myeloma Mutations and Signaling, http://www.genome.jp/kegg-bin/show_pathway?hsa05218

Melanogenesis, http://www.genome.jp/kegg-bin/show_pathway?hsa04916

Renal Cell Cancer Mutations and Signaling, http://www.genome.jp/kegg-bin/show_pathway?hsa05211

Bladder Cancer Mutations and Signaling, http://www.genome.jp/kegg-bin/show_pathway?hsa05219

Prostate Cancer Mutations and Signaling, http://www.genome.jp/kegg-bin/show_pathway?hsa05215

Endometrial Cancer Mutations and Signaling, http://www.genome.jp/kegg-bin/show_pathway?hsa05213

Small Cell Lung Cancer Mutations and Signaling, http://www.genome.jp/kegg-bin/show_pathway?hsa05222

Non-Small Cell Lung Cancer Mutations and Signaling, http://www.genome.jp/kegg-bin/show_pathway?hsa05223

Insulin Signaling Pathway, http://www.genome.jp/kegg-bin/show_pathway?hsa04910

Phosphatidylinositol Signaling Pathway, http://www.genome.jp/kegg-bin/show_pathway?hsa04070

PI3K Pathway: A Potential Ovarian Cancer Therapeutic Target?, http://healthinfoispower.wordpress.com/2009/11/20/pi3k-pathway-a-potential-ovarian-cancer-therapeutic-target/

The PI3K/Akt/mTOR Pathway as a Target for Cancer Therapy, http://blog.genetex.com/cell-signaling-pathway/the-heat-shock-is-on/

EGF Signaling Pathway, http://www.sabiosciences.com/iapp/egf.html

PI3K/AKT/mTOR pathway, http://en.wikipedia.org/wiki/PI3K/AKT_pathway

Cell Signaling, http://en.wikipedia.org/wiki/Cell_signaling

PI3K/Akt Signaling, http://www.cellsignal.com/reference/pathway/Akt_PKB.html

Mitogen-Activated Protein Kinase Cascades, http://www.cellsignal.com/reference/pathway/MAPK_Cascades.html

MAPK/Erk in Growth and Differentiation, http://www.cellsignal.com/reference/pathway/MAPK_ERK_Growth.html

G-Protein-Coupled Receptors Signaling to MAPK/Erk, http://www.cellsignal.com/reference/pathway/MAPK_G_Protein.html

SAPK/JNK Signaling Cascades, http://www.cellsignal.com/reference/pathway/SAPK_JNK.html

Signaling Pathways Activating p38 MAPK, http://www.cellsignal.com/reference/pathway/MAPK_p38.html

Apoptosis Overview, http://www.cellsignal.com/reference/pathway/Apoptosis_Overview.html

Inhibition of Apoptosis, http://www.cellsignal.com/reference/pathway/Apoptosis_Inhibition.html

Death Receptor Signaling, http://www.cellsignal.com/reference/pathway/Death_Receptor.html

Mitochondrial Control of Apoptosis, http://www.cellsignal.com/reference/pathway/Apoptosis_Mitochondrial.html

Autophagy Signaling, http://www.cellsignal.com/reference/pathway/Autophagy.html

PI3K/Akt Binding Partners, http://www.cellsignal.com/reference/pathway/akt_binding.html

PI3K Akt Substrates, http://www.cellsignal.com/reference/pathway/akt_substrates.html

AMPK Signaling, http://www.cellsignal.com/reference/pathway/AMPK.html

Warburg Effect, http://www.cellsignal.com/reference/pathway/warburg_effect.html

Translational Control: Regulation of elF2, http://www.cellsignal.com/reference/pathway/Translation_elF_{—}2.html

Translational Control: Regulation of elF4E and p70 S6 Kinase, http://www.cellsignal.com/reference/pathway/Translation_elF_{—}4.html

mTOR Signaling, http://www.cellsignal.com/reference/pathway/mTor.html

Cell Cycle Control: G1/S Checkpoint, http://www.cellsignal.com/reference/pathway/Cell_Cycle_G1S.html

Cell Cycle Control: G2/M DNA Damage Checkpoint, http://www.cellsignal.com/reference/pathway/Cell_Cycle_G2M_DNA.html

Jak/Stat Signaling: IL-6 Receptor Family, http://www.cellsignal.com/reference/pathway/Jak_Stat_IL_{—}6.html

NF-κB Signaling, http://www.cellsignal.com/reference/pathway/NF_kappaB.html

Toll-like Receptors (TLRs) Pathway, http://www.cellsignal.com/reference/pathway/Toll_Like.html

T Cell Receptor Signaling, http://www.cellsignal.com/reference/pathway/T_Cell_Receptor.html

B Cell Receptor Signaling, http://www.cellsignal.com/reference/pathway/B_Cell_Antigen.html

Wnt/β-Catenin Signaling, http://www.cellsignal.com/reference/pathway/Wnt_beta_Catenin.html

Notch Signaling, http://www.cellsignal.com/reference/pathway/Notch.html

Hedgehog Signaling In Vertebrates, http://www.cellsignal.com/reference/pathway/hedgehog.html

TGF-β Signaling, http://www.cellsignal.com/reference/pathway/TGF_beta.html

ESC Pluripotency and Differentiation, http://www.cellsignal.com/reference/pathway/ESC_pluripotency.html

Regulation of Actin Dynamics, http://www.cellsignal.com/reference/pathway/Regulation_Actin.html

Regulation of Microtubule Dynamics, http://www.cellsignal.com/reference/pathway/Regulation_Microtube.html

Adherens Junction Dynamics, http://www.cellsignal.com/reference/pathway/Adherens_junction.html

Angiogenesis, http://www.cellsignal.com/reference/pathway/Angiogenesis/html

ErbB/HER Signaling, http://www.cellsignal.com/reference/pathway/ErbB_HER.html

Ubiquitin/Proteasome Pathway, http://www.cellsignal.com/reference/pathway/Ubiguitin_Proteasome.html

Wnt/beta-catenin Pathway, http://stke.sciencemag.org/cgi/cm/stkecm;CMP_{—}5533

B Cell Antigen Receptor, http://stke.sciencemag.org/cgi/cm/stkecm;CMP_{—}6909

Cytokinin Signaling Pathway, http://stke.sciencemag.org/cgi/cm/stkecm;CMP_{—}9724

Epidermal Growth Factor Receptor Pathway, http://stke.sciencemag.org/cgi/cm/stkecm;CMP_{—}14987

ERK1/ERK2 MAPK Pathway, http://stke.sciencemag.org/cgi/cm/stkecm;CMP_{—}10705

Estrogen Receptor Pathway, http://stke.sciencemag.org/cgi/cm/stkecm;CMP_{—}7006

Fas Signaling Pathway, http://stke.sciencemag.org/cgi/cm/stkecm;CMP_{—}7966

Fibroblast Growth Factor Receptor Pathway, http://stke.sciencemag.org/cgi/cm/stkecm;CMP_{—}15049

Hedgehog Signaling Pathway, http://stke.sciencemag.org/cgi/cm/stkecm;CMP_{—}19889

Hypoxia-Inducible Factor 1 (HIF-1) Pathway, http://stke.sciencemag.org/cgi/cm/stkecm;CMP_{—}18178

IGF-1 Receptor Signaling through beta-Arrestin, http://stke.sciencemag.org/cgi/cm/stkecm;CMP_{—}15950

Insulin Signaling Pathway, http://stke.sciencemag.org/cgi/cm/stkecm;CMP_{—}12069

Integrin Signaling Pathway, http://stke.sciencemag.org/cgi/cm/stkecm;CMP_{—}6880

Interleukin 1 (IL-1) Pathway, http://stke.sciencemag.org/cgi/cm/stkecm;CMP_{—}21286

Interleukin 13 (IL-13) Pathway, http://stke.sciencemag.org/cgi/cm/stkecm;CMP_{—}7786

Interleukin 4 (IL-4) Pathway, http://stke.sciencemag.org/cgi/cm/stkecm;CMP_{—}7740

Jak-STAT Pathway, http://stke.sciencemag.org/cgi/cm/stkecm;CMP_{—}8301

JNK MAPK Pathway, http://stke.sciencemag.org/cgi/cm/stkecm;CMP_{—}10827

Mitochondrial Pathway of Apoptosis: Antiapoptotic Bcl-2 Family, http://stke.sciencemag.org/cgi/cm/stkecm;CMP_{—}17525

Mitochondrial Pathway of Apoptosis: BH3-only Bcl-2 Family, http://stke.sciencemag.org/cgi/cm/stkecm;CMP_{—}18017

Mitochondrial Pathway of Apoptosis: Caspases, http://stke.sciencemag.org/cg/cm/stkecm;CMP_{—}18019

Mitochondrial Pathway of Apoptosis: Multidomain Bcl-2 Family, http://stke.sciencemag.org/cgi/cm/stkecm;CMP_{—}18015

Natural Killer Cell Receptor Signaling Pathway, http://stke.sciencemag.org/cgi/cm/stkecm;CMP_{—}13625

Notch Signaling Pathway, http://stke.sciencemag.org/cgi/cm/stkecm;CMP_{—}19043

p38 MAPK Pathway, http://stke.sciencemag.org/cgi/cm/stkecm;CMP_{—}10958

PAC1 Receptor Pathway, http://stke.sciencemag.org/cg/cm/stkecm;CMP_{—}8232

PI3K Class IB Pathway, http://stke.sciencemag.org/cgi/cm/stkecm;CMP_{—}19912

PI3K Pathway, http://stke.sciencemag.org/cgi/cm/stkecm;CMP_{—}6557

Seven Transmembrane Receptor Signaling Through beta-Arrestin, http://stke.sciencemag.org/cgi/cm/stkecm;CMP_{—}15654

STAT3 Pathway, http://stke.sciencemag.org/cgi/cm/stkecm;CMP_{—}9229

T Cell Signal Transduction, http://stke.sciencemag.org/cgi/cm/stkecm;CMP_{—}7019

TGF-beta Signaling in Development, http://stke.sciencemag.org/cgi/cm/stkecm;CMP_{—}18196

Toll-Like Receptor Pathway, http://stke.sciencemag.org/cgi/cm/stkecm;CMP_{—}8643

Transforming Growth Factor (TGF) beta Pathway, http://stke.sciencemag.org/cgi/cm/stkecm;CMP_{—}9876

Tumor Necrosis Factor Pathway, http://stke.sciencemag.org/cgi/cm/stkecm;CMP_{—}7107

Type I Interferon (alpha/beta IFN) Pathway, http://stke.sciencemag.org/cgi/cm/stkecm;CMP_{—}8390

Wnt/Ca2+/cyclic GMP, http://stke.sciencemag.org/cgi/cm/stkecm;CMP_{—}12420

Insulin Receptor Signaling (IRS), http://www.cellsignal.com/reference/pathway/Insulin_Receptor.html

Caspase Cascade, http://www.sabiosciences.com/pathway.php?sn=Caspase_Cascade

In such diagrams, lines terminating in arrowheads were assigned relationship values of 1 (e.g., stimulating) in the matrix, whereas lines terminating in lateral lines (in place of arrowheads) were assigned relationship values of −1 (e.g., inhibiting) in the matrix. Feedback relationships between two factors were giving two separate complementary relationship values. Other relationships were assigned values of zero. The factors, including compound factors, modelled in the cell model matrix numbered 608, with 369,664 (608 squared) unique relationships, and are as follows:

Possible Remission, PI3K, AKT, AKT2, mTORRaptor, Ras/KRas, C-Raf/Raf-1, MEK1/2, ERK/MAPK, Caspase Cascade, APOPTOSIS, Cell Proliferation, Cell Motility/Migration/Spread, Angiogenesis, Warberg Effect, Autophagy, Ca++, cAMP, cGMP, NADPH, 37694, 2-HG, 4EBP1, 5HT 1, 5HT 1R, 5HT 2, 5HT 2R, 5HT 4, 5HT 4R, 5HT 5, 5HT 5R, 5HT 6, 5HT 6R, 5HT 7, 5HT 7R, A20, AAs, ABIN-2(TNIP-2), Acetyl-CoA, Acidosis, AdenylateCyclase, Adiponectin, Adiponectin R APPL, Age, AIF, Ajuba-LIM, ALK/CD30, ALK Kinase, alphaKG, AML1, AML1 Genes, AML1-ETO, AMPK, Androgens, ANGPT-1, ANGPT-2, AP-1, Apaf-1, APC, AR, ASK1, ATF1/2, ATG1, ATM, ATP Depletion, ATR, AuroraA, AuroraB, AXIN1, BACH1, Bad, BAG1, Bak, b-Arrestin2, BASC Complex, Bax, b-Catenin, b-CateninTCF, B-Cell R, Bcl-2, Bcl-XL, BCR-ABL, Beclin, BECN1, BH3, Bid, Bim, Bipolar Spindle Formation, Blocked Diff, BNIP3, b-parvin, B-Raf, BRCA1, BRCA1/BARD1, BRCA2, C/EBPa, C/EBPa Genes, C3G, Ca++Influx, c-Abl, CAD, Calcineurin(PP2B), Calpain, CaM, CaMK, Caspase10, Caspase12, Caspase2, Caspase3, Caspase6, Caspase7, Caspase8, Caspase9, Caveolin, CBL, CD40, CD40-Ligand, Cdc25, Cdc37, Cdc42, CDK1, CDK2, Centrosome Dup&Func, Centrosome Function, Ceramide, c-Fos, Chaperone, CHK1, CHK2, Chromosome Resolution, Citrate, c-Jun, c-KIT, CKS1, CLASP, CLIP, c-Myb, c-Myc, Cofilin, Condensin1, COP1, COX2, cPLA2, CREB, CRK, CRKL, CRMP2, CSNK1, CSNK2, ctlP, Cul3, CyclinA1, CyclinB/Cdc2, CyclinD/CDK4, CyclinE/CDK2, CyclinG, CytochromeC, CytokineR, Cytokinesis, DA, DAB2IP, DAG, DAPK, DAXX, DCC, DDR1, DeliveryMT to +Ends, Diabetes, Diabetic Complications, Digh1, Dishevelled, DKK1,3, Dmp1, DNA Damage GS, DNA Repair, DNA-PK, DOCK, DOKR, Dopamine1R, Dopamine2R, DUSP1, E2F, EB1, E-cadherin, ECM, eEF2K, Eg5, EGF, EGFR/ErbB1, eLactate, elF4E1, ELK-1, EMT, EndoG, eNOS, EPO, ER Stress, EstrogenR, FADD, FAK, FAN, FANC Complex, FANCD2, FANCD2/BRCA2, Fas, FasL, FattyAcids, FGF, FGFR, FLICE, FLIP, FLT3, FLT3LG, FOXC2, FOXM1, FOXO1/3, FRG, Frizzled, FUMH, FUSED Homolog, Fyn/Shc, G2M Checkpoint, G6PO4, GAB1, Gab2, GADD45, GADS, GCSFR, GeneRegulation, GH, GHR, GLI, GLU-4, Glucose, GlucoseTransporters, Glutamate, Glutamine, Glutaminolysis, Glutathione/GSH, Glycolysis, GMCSFR, GPCR, GProtein, GranzymeB, Grb2, GSK3, GuanylylCyclase, H2AX, HbAC1, HBP1, hdm2, HER2/neu, HGF, HIC1, HIF1/2a, HMGB1, HMG-CoA-Rtase, hMLH1/hMSH2, hMSH3/hMSH6, HOXD10, HPH, Hrk/DP5, HSP27, HSP90, hTERT, HtrA2, HuR, Hyper-glycemia, Hyperinsulinemia, Hypoxia, I-1, IAP, ICAD, ICAM-1, ICIS, IDH1OR2, IDH1or2Mutant, IFN/IL10, IGF-1, IGF-2, IGF-BP3, IGFR, IkB, IKK, IL2/3, IL-6, IL-8, iLactate, ILK, ING2, iNOS, INS, INSR, Insulin Resistance, Integrina5b1, IP3, IRAKS, IRE1, IRF3, IRS-1, Ischemia, Isocitrate, ITGA/B, Jab1, JAG1, JAG2, JAKs, JNKs, JunD, Kinetochore Function, KITLG, KLF4, KSR, LAT, Lck, Leptin, let-7-OFF, Leukotrienes, LIMK, Lithium+, Livin, LKB1, LL5b, Lyn, Mad:Max, MADD, MagRacGap, Malate, MAP1b, MAP2K6, MAPKKKs, MARK, MARK2, MCAK, Mcl-1, MCSFR, MCT, mDIA, MDM2, MDM-X, ME1, MEF2, MEKK, MEN, Menin, MET, Microtubular Dynamics, Midzone Formation, miR-106A-OFF, miR-106A-ON, miR-10b-ON, miR-15/16, miR-206-ON, miR-20a-ON, miR-21-ON, miR-34a-OFF, miR-372/373, MITF, Mitochondrion, Miz1, MK2, MKKs, MKP, MLCK, MLK1/3, MNK1/2, MSK1/2, MST1/2, MT Catastrophe, MT Polymeraization, MT Stability, mTORRictor, Mule, Myc:Max, MYD88, Myosin, Myt1, NADPH Oxidase, N-cadherin, Nck, NE Alpha1, NE Alpha1R, NE Alpha2, NE Alpha2R, NE Beta, NE BetaR, NEDD4-1, NEK2, Neurofibromin, NF-1, NFAT, NF-IL-6, NF-kB, NICD, NIK, NK-1R, NKX3.1, NMP-ALK FP, NO, NOTCH, NOTCH Ligand, Noxa, Obesity, Ob-Rb, OCT 1, ONOO−, p130CAS, p14(ARF), p15INK4b, p16INK4a, p19(ARF), p21Cip, p27Kip, p38MAPK, P48, p53, p53AIP, p53R2, p70S6K, p73, p9ORSK, PAK, Par6, Par6/Par3, PARP, PARP Cleaved, Paxillin, PDCD4, PDE, PDE3B, PDGF, PDGFR, PDH, PDK, PDK1, PentPO4Path, PEP, PFK1, PFK2, PGE2, PhosphatidicAcid, PIAS, PIDD, PIGs, Pim1/Pim2, PIP2, PIP3, PIP5K, pirh2, PIX, PKA, PKC, PKD, PKM2, PKR, plakoglobin, plakoglobinTCF, PLC, PLD1, PLK, PLZF-RARa, PML-RARa, Posh, PP1, PP2A, PPARa, PPARb, PPARd, PPARg, PRAS40, P-Rex1, Prog Rec, PSA, PTCH, PTEN, Ptg1R, PTP1B, PU.1, PU.1 Genes, Puma, P-YC1, PYK2, Pyruvate, Rac1, RacGEF, Rad51, RAGE, RAIDD, Ral, RALBP1, RaIGDS, Rap, RARa Genes, RARb/RXR, RASSF1A NOREAIA, Rb, RECK, Redd1/2, ReIB, Retinoic Acid, Rheb, RhoA, RhoGAP, RhoGEF, RIP1, RIP2, RKIP, RNR, ROCK1, Rok-alpha, ROS, RRM1/RRM2, S6, SAPK, Sck, SCO2, SESNs, SFRP1, SGK, SHH, SHIP, SHP2, SIRT1, SKIP, Skp2, SLP-76, Slug, Smac/Diablo, Smad2/3, Smad2/3/Smad4, Smad4, Smad6/7, SMase, SMO, Smurf1/2, Snail, SOCS, Sos, Spindle Checkpoint, Spred1, SPRY, Src, STAT1, STAT3, STATS, Stathmin, SubstanceP, Survivin, Syk, TAB1, TACC, TAK1, TAOK, Tau Protein, tBid, TCA, T-Cell R, Telomerase, TESK, TGFa, TGFb, TGFbR1, TGFbR2, Thioredoxin Oxidized, Thioredoxin Peroxidase, Thioredoxin Reduced, Thioredoxin Reductase, TIE-1, TIE-2, TIGAR, Tiram1, TIRAP/Mal, TLR2/4, TNFa, TNF-R1, TNF-R2, TPPP, TPX2, TRADD, TRAF2, TRAF3, TRAF6, TRAIL, TRAILR, Trio, TSC2/TSC1, Twist, Ubiq Ligase, UCP2, UCP2/3, uDUSP1, Unfolded Protein1, Vav1, Vav2, VCAM-1, VEGF, VEGFR2, VEPTP, VHL, VHR, Vimentin, VRAP, Wee1, Wip1, Wnt, XBP1, XIAP, and ZAP70.

Compound factors in the above included Possible Remission, Caspase Cascade, APOPTOSIS, Cell Proliferation, Cell Motility/Migration/Spread, Angiogenesis, Warberg Effect, and Autophagy and were configured based on the published literature as well. Some or all of the above factors are involved in the regulation of cellular processes relating to cell growth, such as apoptosis. When taken together, the degree of upregulation or downregulation of these cellular processes are indicative of the probability of remission of the cancer. Examples using this cell model matrix to perform simulations are discussed below with reference to the method 30 of FIG. 8.

### Example 1

### Small Cell Lung Cancer

A gene mutation profile for small cell lung cancer was provided that included the following gene mutations Myc, p53, retinoblastoma gene (Rb), and PTEN. A corresponding disease state vector was established as described at step 34 of the method 30. The genes p53, Rb, and PTEN are tumor suppressor genes, and thus their mutated values were locked to −1 to signify that the protein and its cellular signaling are suppressed/inhibited. The gene Myc is an oncogene, and thus its mutated value was locked to 1. All other values of the disease state vector were set to 0, but not locked as an enforced policy.

Next, as described at steps 36-40, the disease state vector was used as the starting point for a series of iterative multiplications with the cell model matrix. In this example, a stabilized diseased cell state vector was reached after five iterations, though a total of 27 iterations were performed to confirm pattern stabilization.

Output of step 42, as shown in Table 1, included an indication of the stabilized diseased cell state vector, in which PI3K, AKT, mTORRaptor, Ras, C-Raf/Raf-1, MEK1/2, and ERK/MAPK all exhibited values of 1, indicating that the initial disease state vector for this gene mutation profile produced a persistent cancerous state with both the PI3K/AKT/mTOR and RAS/Raf/MEK/ERK pathways activated. The activation of these pathways was interpreted by the server 58, which determined a composite value for apoptosis of −1, indicating that apoptosis was effectively inhibited. The value of another composite variable indicative of remission was also −1, indicating that there was no reasonable probability of remission without intervention.

Initial therapy with an AKT inhibitor was selected for evaluation first because of the PTEN mutation. A treatment state vector was established as described at step 34 by modifying the disease state vector to lock the AKT value to less than or equal to −0.5. In this example, the value of −0.5 was chosen to represent 50% inhibition of AKT protein expression/signaling. All other previously determined values for the disease state vector were unmodified for the treatment state vector.

A series of iterative multiplications with the cell model matrix were performed as described at steps 36-40 using the treatment state vector as the starting point. In this example, a stabilized treated cell state vector was reached after 9 iterations, though a total of 35 iterations were performed to confirm stabilization.

Output of step 42, as shown in Table 1, included an indication of the stabilized treated cell state vector in which PI3K, mTORRaptor, Ras, C-Raf/Raf-1, MEK1/2, and ERK/MAPK all exhibit values of −1, indicating that the cancer signaling profile was reversed. The value of AKT remained −0.5, as it was initially locked. The value for apoptosis was 1, indicating that apoptosis was re-established. The value for remission was 1, indicating that stable remission is possible when an AKT inhibitor is administered to a patient exhibiting this gene mutation profile. Therefore, no other treatment options were evaluated for this gene profile.

TABLE 1

| | | Treated cell state |
|---|---|---|
| | Diseased cell state | vector values after |
| | vector values | AKT inhibitor |
| PI3K | 1 | −1 |
| AKT | 1 | −0.5 |
| mTORRaptor | 1 | −1 |
| Ras | 1 | −1 |
| C-Raf/Raf-1 | 1 | −1 |
| MEK1/2 | 1 | −1 |
| ERK/MAPK | 1 | −1 |
| Apoptosis | −1 | 1 |
| Remission possible | −1 | 1 |

As reported in WO2010/006438, published Jan. 21, 2010, the entire contents of which are hereby incorporated by reference, Example 3 shows the nude mouse model of human SCLC that was used to evaluate the in vivo efficacy of Akt inhibitors in comparison with several known chemotherapeutic agents. Nude mice were obtained form the National Cancer Institute and the SHP-77 human SCLC cell line was chosen for metastatic tumor xenografts. The control group consisted of 10 animals, each of which were administered bilateral thigh injections of a prescribed volume of tumor cells. There were 6 treatment groups, each containing 5 animals: COTI-2 (an AKT inhibitor), COTI-4, COTI-219, Taxotere® (docetaxel), Cisplatin® (cis-diamminedichloroplatinum) and Tarceva® (erlotinib, an EGFR inhibitor) The therapeutic agent was administered by intraperitoneal (IP) injection on alternate days beginning on Day 3 post tumor cell injection. Each animal in a treatment group was administered bilateral thigh injections with the same prescribed volume of tumor cells as the control animals. Treatment continued for 31 days, following which the animals were euthanized and tissues were collected for subsequent analysis. The final tumor size in mm³ is reported in FIG. 1 and the number of tumors is reported in FIG. 2 of WO2010/006438.

The Akt inhibitor COTI-2 showed a marked decrease in tumor growth as compared with both the control and conventional agents. Control animals produced tumors having a mean volume of 260+/−33 mm³. Animals treated with COTI-2 produced tumors of mean volume 9.9 mm³, while those treated with COTI-219 produced tumors having mean volume 53+/−28 mm³. This compared well with those treated with Cisplatin®, which produced tumors having means volume 132+/−26 mm³ and those treated with Taxotere®, which produced tumors having mean volume 183 mm³. Animals treated with Tarceva® died before study conclusion at 31 days.

The AKT inhibitor COTI-2 also showed a marked decrease in number of tumors as compared with both the control and conventional agents. Control animals produced an average of 0.9 tumors per injection site, whereas those treated with COTI-2 produced 0.28, those treated with COTI-219 produced 0.38, those treated with Cisplatin® produced 0.48 and those treated with Taxotere® produced 0.48. Animals treated with Tarceva® died before study conclusion at 31 days.

The above data show the efficacy of Akt inhibitors in vivo against SCLC cell lines and confirm the above predictions of efficacy made using the FCM simulation.

### Example 2

### Glioma

A gene mutation profile for glioma was provided that included the following gene mutations EGFR/ErbB1, MDM2, p14ARF, p16INK4a, and PTEN. A corresponding disease state vector was established as described at step 34 of the method 30. The genes p14ARF, p16INK4a, and PTEN are tumor suppressor genes, and thus their mutated values were locked to −1. The genes EGFR and MDM2 are oncogenes, and thus their mutated values were locked to 1. All other values of the disease state vector were set to 0, but not locked as an enforced policy.

Next, as described at steps 36-40, the disease state vector was used as the starting point for a series of iterative multiplications with the cell model matrix. In this example, a stabilized diseased cell state vector was reached after 4 iterations, though a total of 19 iterations were performed to confirm stabilization.

Output of step 42, as shown in Table 2, included an indication of the stabilized diseased cell state vector, in which PI3K, AKT, mTORRaptor, Ras, C-Raf/Raf-1, MEK1/2, and ERK/MAPK all exhibited values of 1, indicating that the initial disease state vector for this gene mutation profile produced a persistent cancerous state with both the PI3K/Akt/mTOR and RAS/Raf/MEK/ERK pathways activated. The activation of these pathways was interpreted by the server 58, which determined a composite value for apoptosis of −1, indicating that apoptosis was effectively inhibited. The value of another composite variable indicative of remission was also −1, indicating that there was no reasonable probability of remission without intervention.

Initial therapy with an AKT inhibitor was selected for evaluation first because of the PTEN mutation. A treatment state vector was established as described at step 34 by modifying the disease state vector to lock the AKT value to −1. All other previously determined values for the disease state vector were unmodified for the treatment state vector.

A series of iterative multiplications with the cell model matrix were performed as described at steps 36-40 using the treatment state vector as the starting point. The treatment state vector configured to inhibit AKT maximally initially produced some positive changes including silencing mTOR, turning on apoptosis and inducing a possible remission, as shown in Table 2. However, the Ras/Raf/MEK/ERK pathway was not silenced and at the new stable state the cancer signaling profile was restored and remission was not possible. Apoptosis remained active but was ineffective.

Due to the failure of the initial treatment state vector, therapy with a PI3K inhibitor was evaluated next. A second treatment state vector was established as described at step 34 by modifying the disease state vector to lock the PI3K value −0.7. All other previously determined values for the disease state vector were unmodified for the treatment state vector and the locked AKT value of the first treatment vector was released (i.e., set to 0 and unlocked).

Another series of iterative multiplications with the cell model matrix were performed as described at steps 36-40 using the second treatment state vector as the starting point. In this example, a stabilized treated cell state vector was reached within 66 iterations, though a total of 75 iterations were performed to confirm stabilization.

TABLE 2

| | Diseased | Initial treated cell | Second treated cell |
|---|---|---|---|
| | cell state | state vector values | state vector values |
| | vector values | after AKT inhibitor | after PI3K inhibitor |
| PI3K | 1 | 1 | −0.7 |
| AKT | 1 | −1 | −1 |
| mTORRaptor | 1 | −1 | −1 |
| Ras | 1 | 1 | −1 |
| C-Raf/Raf-1 | 1 | 1 | −1 |
| MEK1/2 | 1 | 1 | −1 |
| ERK/MAPK | 1 | 1 | −1 |
| Apoptosis | −1 | 1 | 1 |
| Remission | −1 | 0 | 1 |
| possible | | | |

Output of step 42, as shown in Table 2, included an indication of the stabilized second treated cell state vector in which AKT, mTORRaptor, Ras, C-Raf/Raf-1, MEK1/2, and ERK/MAPK all exhibit values of −1, indicating that the cancer signaling profile was reversed. The value of PI3K remained −0.7, as it was locked. The value for apoptosis was 1, indicating that apoptosis was re-established. The value for remission was 1, indicating that stable remission is possible by inhibiting PI3K. The possibility of a remission requires about or more than 70% (−0.7) inhibition of PI3K signaling inside the central nervous system (CNS), and therefore the inhibitor must penetrate the blood-brain barrier to be effective.

Alternative treatments for this gene profile were also simulated and their results are as follows. Inhibiting mTORRaptor produced a stable cell state vector in which the cancer signaling profile was not reversed, apoptosis remained at −1, and a remission was unlikely. Inhibiting Raf-1 produced a stable cell state vector in which the cancer signaling profile was not reversed, apoptosis remained at −1, and a remission was unlikely. Inhibiting MEK produced a stable cell state vector in which the cancer signaling profile was not reversed, apoptosis remained at −1, and a remission was unlikely.

Accordingly, a patient exhibiting this gene mutation profile could first have a PI3K inhibitor that penetrates the blood-brain barrier added to their glioma therapy. A second option, if the PI3K inhibitor is ineffective, is to add an AKT inhibitor that penetrates the blood-brain barrier.

As reported in WO2010/006438, Example 7 shows the in vivo effect of an AKT inhibitor on glioma. Malignant U87 human glioma (brain tumour) cells in Matrigel™ were injected sub-cutaneously into hind legs of nude mice, allowed to grow to 200-300 mm³, then treated 3 times per week (Mon, Wed, Fri) with indicated concentrations of the AKT inhibitor COTI-2 (in isotonic saline, as a cloudy liquid, total volume of 1 ml per injection). Tumour volumes were estimated by caliper measurement. The results are shown in FIGS. 6A and 6B of WO2010/006438.

Tumour volumes were graphed as means±standard error (SE) (n=11-14 for each data point). The asterisk indicates a significant difference (p<0.05) between the 8 mg/kg treatment group and both the saline control and 4 mg/kg treatment groups. There was no significant difference between the 4 mg/kg group and the saline control group.

Tumour volumes were also graphed as fractional increase in volume, to correct for differences in starting volume, ±SE. The asterisk indicates a significant difference (p<0.05) between the 8 mg/kg treatment group and both the saline control and 4 mg/kg treatment groups. There was no significant difference between the 4 mg/kg group and the saline control group. The flag ( [symbol] ) indicates a significant difference between the 8 mg/kg group and the saline group, but not between the 8 mg/kg group and the 4 mg/kg group.

These results show that an AKT inhibitor has some limited effect in the in vivo treatment of established human brain tumors. The AKT inhibitor delayed tumor growth by about 25% at a dosage of 8 mg/kg given three times per week. No significant effect was observed at a dosage of 4 mg/kg. These results confirm the above predictions of the FCM simulation that an AKT inhibitor will have some limited effect, but ultimately be insufficient in establishing complete remission for glioma.

### Example 3

### Ovarian Cancer

A gene mutation profile for ovarian cancer was provided that included the following gene mutations BRCA1, BRCA2, and PTEN. A corresponding disease state vector was established as described at step 34 of the method 30. The genes BRCA1, BRCA2, and PTEN are tumor suppressor genes, and thus their mutated values were locked to −1. All other values of the disease state vector were set to 0, but not locked as an enforced policy.

Next, as described at steps 36-40, the disease state vector was used as the starting point for a series of iterative multiplications with the cell model matrix. In this example, a stabilized diseased cell state vector was reached after 6 iterations, though a total of 19 iterations were performed to confirm stabilization.

Output of step 42, as shown in Table 3, included an indication of the stabilized diseased cell state vector, in which PI3K, AKT, mTORRaptor, Ras, C-Raf/Raf-1, MEK1/2, and ERK/MAPK all exhibited values of 1, indicating that the initial disease state vector for this gene mutation profile produced a persistent cancerous state with both the PI3K/Akt/mTOR and RAS/Raf/MEK/ERK pathways activated. The activation of these pathways was interpreted by the server 58, which determined a composite value for apoptosis of −1, indicating that apoptosis was effectively inhibited. The value of another composite variable indicative of remission was also −1, indicating that there was no reasonable probability of remission without intervention.

Initial therapy with an AKT inhibitor was selected for evaluation first because of the PTEN mutation. A treatment state vector was established as described at step 34 by modifying the disease state vector to lock the AKT value to less than or equal to −0.75. All other previously determined values for the disease state vector were unmodified for the treatment state vector.

A series of iterative multiplications with the cell model matrix were performed as described at steps 36-40 using the treatment state vector as the starting point. In this example, a stabilized treated cell state vector was reached within 24 iterations, though a total of 33 iterations were performed to confirm stabilization.

Output of step 42, as shown in Table 3, included an indication of the stabilized treated cell state vector in which PI3K, mTORRaptor, Ras, C-Raf/Raf-1, MEK1/2, and ERK/MAPK all exhibit values of −1, indicating that the cancer signaling profile was reversed. The value of AKT remained −0.75, as it was initially locked. The value for apoptosis was 1, indicating that apoptosis was re-established. The value for remission was 1, indicating that stable remission is possible when an AKT inhibitor is administered to a patient exhibiting this gene mutation profile. The value for remission stabilized to 1 after two iterations, indicating that the possibility of remission occurs relatively early.

TABLE 3

| | | Treated cell state |
|---|---|---|
| | Diseased cell state | vector values after |
| | vector values | AKT inhibitor |
| PI3K | 1 | −1 |
| AKT | 1 | −0.75 |
| mTORRaptor | 1 | −1 |
| Ras | 1 | −1 |
| C-Raf/Raf-1 | 1 | −1 |
| MEK1/2 | 1 | −1 |
| ERK/MAPK | 1 | −1 |
| Apoptosis | −1 | 1 |
| Remission possible | −1 | 1 |

Alternative treatments for this gene profile were also simulated and their results are as follows. Inhibiting PI3K produced a stable cell state vector in which the cancer signaling profile was only partially reversed, apoptosis remained at −1, and a remission was uncertain. Inhibiting mTORRaptor produced a stable cell state vector in which the cancer signaling profile was not reversed, apoptosis remained at −1, and a remission was unlikely. Inhibiting Raf-1 produced a stable cell state vector in which the cancer signaling profile was not reversed, apoptosis remained at −1, and a remission was unlikely. Inhibiting MEK produced a stable cell state vector in which the cancer signaling profile was not reversed, apoptosis remained −1, and a remission was unlikely.

Accordingly, administering an AKT inhibitor or a combination of an AKT inhibitor and Taxol™ (paclitaxel) to a patient exhibiting this gene mutation profile has a high probability of success.

### Example 4

### Pancreatic cancer

A gene mutation profile for pancreatic cancer was provided that included the following gene mutations BRCA2, Her2/neu, p16INK4a, Smad4, p53, and KRAS. A corresponding disease state vector was established as described at step 34 of the method 30. The genes BRCA2, p16INK4a, Smad4, and P53 are tumor suppressor genes, and thus their mutated values were locked to −1. The genes Her2/neu and KRAS are oncogenes, and thus their mutated values were locked to 1. All other values of the disease state vector were set to 0, but not locked as an enforced policy.

Next, as described at steps 36-40, the disease state vector was used as the starting point for a series of iterative multiplications with the cell model matrix. In this example, a stabilized diseased cell state vector was reached after 4 iterations, though a total of 18 iterations were performed to confirm stabilization.

Output of step 42, as shown in Table 4, included an indication of the stabilized diseased cell state vector, in which PI3K, AKT, mTORRaptor, Ras, C-Raf/Raf-1, MEK1/2, and ERK/MAPK all exhibited values of 1, indicating that the initial disease state vector for this gene mutation profile produced a persistent cancerous state with both the PI3K/Akt/mTOR and RAS/Raf/MEK/ERK pathways activated. The activation of these pathways was interpreted by the server 58, which determined a composite value for apoptosis of −1, indicating that apoptosis was effectively inhibited. The value of another composite variable indicative of remission was also −1, indicating that there was no reasonable probability of remission without intervention.

Therapy with a PI3K inhibitor was selected for evaluation first. A treatment state vector was established as described at step 34 by modifying the disease state vector to lock the PI3K value to −0.6. All other previously determined values for the disease state vector were unmodified for the treatment state vector.

A series of iterative multiplications with the cell model matrix were performed as described at steps 36-40 using the treatment state vector as the starting point. In this example, a stabilized treated cell state vector was reached within 19 iterations, though a total of 28 iterations were performed to confirm stabilization.

Output of step 42, as shown in Table 4, included an indication of the stabilized first treated cell state vector in which AKT, mTORRaptor, Ras, C-Raf/Raf-1, MEK1/2, and ERK/MAPK all exhibit values of −1, indicating that the cancer signaling profile was reversed. The value of PI3K remained −0.6, as it was locked. The value for apoptosis was 1, indicating that apoptosis was re-established. The value for remission was 1, indicating that stable remission is possible by inhibiting PI3K.

Next, therapy using a MEK inhibitor and a varied amount of PI3K was selected for evaluation. A second treatment state vector was established as described at step 34 by modifying the disease state vector to lock the MEK1/2 value to between −0.5 and −0.75 (−0.5 was selected) and to lock the PI3K value to −0.5. All other previously determined values for the disease state vector were unmodified for the treatment state vector.

Another series of iterative multiplications with the cell model matrix were performed as described at steps 36-40 using the second treatment state vector as the starting point. In this example, a stabilized treated cell state vector was reached within 18 iterations, though a total of 27 iterations were performed to confirm stabilization.

Output of step 42, as shown in Table 4, included an indication of the stabilized second treated cell state vector in which AKT, mTORRaptor, Ras, C-Raf/Raf-1, and ERK/MAPK all exhibit values of −1, indicating that the cancer signaling profile was reversed. The value of PI3K and MEK1/2 remained −0.5, as they were locked. The value for apoptosis was 1, indicating that apoptosis was re-established. The value for remission was 1, indicating that stable remission is possible by inhibiting PI3K and MEK. The combination of PI3K and MEK inhibition provided a wider range of potentially effective doses.

An alternative treatment for this gene profile was also simulated and its results are as follows. Inhibiting both AKT and MEK produced a stable cell state vector in which the cancer signaling profile was reversed, apoptosis remained at 1, and a remission was possible. The combination of AKT and MEK inhibition provided a narrower range of effective doses. However, as long as both PI3K and MEK are inhibited at about or more than 90%, remission is also possible.

TABLE 4

| | | First treated cell | Second treated cell |
|---|---|---|---|
| | Diseased | state vector | state vector values |
| | cell state | values after | after PI3K and MEK |
| | vector values | PI3K inhibitor | inhibitors |
| PI3K | 1 | −0.6 | −0.5 |
| AKT | 1 | −1 | −1 |
| mTORRaptor | 1 | −1 | −1 |
| Ras | 1 | −1 | −1 |
| C-Raf/Raf-1 | 1 | −1 | −1 |
| MEK1/2 | 1 | −1 | −0.5 |
| ERK/MAPK | 1 | −1 | −1 |
| Apoptosis | −1 | 1 | 1 |
| Remission | −1 | 1 | 1 |
| possible | | | |

Accordingly, a patient exhibiting this gene mutation profile could first be given PI3K and MEK inhibiters, and as long as PI3K and MEK are inhibited at about or more than 50%, remission would be possible.

### Example 5

### Colorectal Cancer with KRAS Mutation

A gene mutation profile for colorectal cancer was provided that included the following gene mutations APC, DCC, p53, and KRAS. A corresponding disease state vector was established as described at step 34 of the method 30. The genes APC, DCC, and p53 are tumor suppressor genes, and thus their mutated values were locked to −1. The gene KRAS is an oncogene, and thus its mutated values was locked to 1. All other values of the disease state vector were set to 0, but not locked as an enforced policy.

Next, as described at steps 36-40, the disease state vector was used as the starting point for a series of iterative multiplications with the cell model matrix. In this example, a stabilized diseased cell state vector was reached after 7 iterations, though a total of 18 iterations were performed to confirm stabilization.

Output of step 42, as shown in Table 5, included an indication of the stabilized diseased cell state vector, in which PI3K, AKT, mTORRaptor, Ras, C-Raf/Raf-1, MEK1/2, ERK/MAPK, and EGFR/ErbB1 all exhibited values of 1, indicating that the initial disease state vector for this gene mutation profile produced a persistent cancerous state with both the PI3K/Akt/mTOR and RAS/Raf/MEK/ERK pathways activated and EGFR signaling on. The activation of these pathways was interpreted by the server 58, which determined a composite value for apoptosis of −1, indicating that apoptosis was effectively inhibited. The value of another composite variable indicative of remission was also −1, indicating that there was no reasonable probability of remission without intervention.

Initial therapy with an EGFR inhibitor (such as cetuximab) was selected for evaluation first. However, it was anticipated to likely be ineffective due to the presence of the KRAS mutation. A treatment state vector was established as described at step 34 by modifying the disease state vector to lock the EGF value to −1. All other previously determined values for the disease state vector were unmodified for the treatment state vector.

A series of iterative multiplications with the cell model matrix were performed as described at steps 36-40 using the treatment state vector as the starting point. In this example, a stabilized treated cell state vector was reached within 8 iterations, though a total of 16 iterations were performed to confirm stabilization.

Output of step 42, as shown in Table 5, included a first treated cell state vector indicating that inhibiting EGF has produced a new stable state in which the cancer signaling profile has not been reversed, apoptosis is still off (−1), and a remission is not possible. Signaling via EGFR/ErbB1 was also found to be only transiently and incompletely inhibited.

Due to the failure of the first treatment state vector, therapy with a PI3K inhibitor was evaluated next. A second treatment state vector was established as described at step 34 by modifying the disease state vector to lock the PI3K value −0.75. All other previously determined values for the disease state vector were unmodified for the treatment state vector and the locked EGF value of the initial treatment vector was released (i.e., set to 0 and unlocked).

Another series of iterative multiplications with the cell model matrix were performed as described at steps 36-40 using the second treatment state vector as the starting point. In this example, a stabilized treated cell state vector was reached within 31 iterations, though a total of 40 iterations were performed to confirm stabilization.

TABLE 5

| | Diseased | First treated cell | Second treated cell |
|---|---|---|---|
| | cell state | state vector values | state vector values |
| | vector values | after EGF inhibitor | after PI3K inhibitor |
| PI3K | 1 | 1 | −0.75 |
| AKT | 1 | 1 | −1 |
| mTORRaptor | 1 | 1 | −1 |
| Ras | 1 | 1 | −1 |
| C-Raf/Raf-1 | 1 | 1 | −1 |
| MEK1/2 | 1 | 1 | −1 |
| ERK/MAPK | 1 | 1 | −1 |
| EGFR/ErbB1 | 1 | 0 | −1 |
| Apoptosis | −1 | −1 | 1 |
| Remission | −1 | −1 | 1 |
| possible | | | |

Output of step 42, as shown in Table 5, included an indication of the stabilized second treated cell state vector in which AKT, mTORRaptor, Ras, C-Raf/Raf-1, MEK1/2, and ERK/MAPK, and EGFR/ErbB1 all exhibit values of −1, indicating that the cancer signaling profile was reversed. Signaling via EGFR/ErbB1 was found to be inhibited. The value of PI3K remained −0.75, as it was locked. The value for apoptosis was 1, indicating that apoptosis was re-established. The value for remission was 1, indicating that stable remission is possible when a PI3K inhibitor is administered to a patient exhibiting this gene mutation profile.

As reported in WO2010/006438, Example 28 shows the in vivo effect of an AKT inhibitor (COTI-2) and an EGFR inhibitor (Erbitux®, or cetuximab) on the treatment of the KRAS mutant colorectal cancer cell line HCT-116. Ninety mice were inoculated subcutaneously in the right flank with 0.1 ml of a 50% RPMI/50% Matrigel™ (BD Biosciences, Bedford, Mass.) mixture containing a suspension of HCT-116 tumor cells (approximately 5×10⁶ cells/mouse). Three days following inoculation, tumors were measured using vernier calipers and tumor weight was calculated using the animal study management software, Study Director V.1.6.80 (Study Log) (Cancer Res 59: 1049-1053). Seventy mice with average group tumor sizes of 136 mg, with mice ranging from 73 to 194 mg, were pair-matched into seven groups of ten by random equilibration using Study Director (Day 1). Body weights were recorded when the mice were pair-matched and then taken twice weekly thereafter in conjunction with tumor measurements throughout the study. Gross observations were made at least once a day. On Day 1 all groups were dosed intravenously and/or intraperitoneally with respect to their assigned group (See Table 40). The COTI-2 single agent groups were treated 3 times per week on every other day for the first week of the study then dosed 5 times per week for the remainder of the study. In the COTI-2 and Erbitux® combination treatment groups, COTI-2 was administered 3 times per week on every other day. Erbitux® (1 mg/dose) was administered intraperitoneally every three days for five treatments (q3dx5) at 0.5 ml/mouse dose volume. The mice were sacrificed by regulated CO₂ when the individual mouse tumor volume reached approximately 2000 mg.

Table 40 of WO2010/006438 shows that there was no significant difference in the mean survival of the Erbitux® only treated group when compared to the vehicle control group. This confirms the above predictions of the FCM simulation, namely that an EGFR inhibitor is ineffective in the treatment of KRAS mutant colorectal cancer.

### Example 6

### Colorectal Cancer without KRAS Mutation

A gene mutation profile for colorectal cancer was provided that included the following gene mutations APC, DCC, and p53. A corresponding disease state vector was established as described at step 34 of the method 30. The genes APC, DCC, and p53 are tumor suppressor genes, and thus their mutated values were locked to −1. All other values of the disease state vector were set to 0, but not locked as an enforced policy.

Next, as described at steps 36-40, the disease state vector was used as the starting point for a series of iterative multiplications with the cell model matrix. In this example, a stabilized diseased cell state vector was reached after 8 iterations, though a total of 27 iterations were performed to confirm stabilization.

Output of step 42, as shown in Table 6, included an indication of the stabilized diseased cell state vector, in which PI3K, AKT, mTORRaptor, Ras, C-Raf/Raf-1, MEK1/2, ERK/MAPK, and EGFR/ErbB1 all exhibited values of 1, indicating that the initial disease state vector for this gene mutation profile produced a persistent cancerous state with both the PI3K/Akt/mTOR and RAS/Raf/MEK/ERK pathways activated and EGFR signaling on. The activation of these pathways was interpreted by the server 58, which determined a composite value for apoptosis of −1, indicating that apoptosis was effectively inhibited. The value of another composite variable indicative of remission was also −1, indicating that there was no reasonable probability of remission without intervention.

Initial therapy with an EGFR inhibitor (such as cetuximab) was selected for evaluation first. A treatment state vector was established as described at step 34 by modifying the disease state vector to lock the EGF value to −1. All other previously determined values for the disease state vector were unmodified for the treatment state vector.

A series of iterative multiplications with the cell model matrix were performed as described at steps 36-40 using the treatment state vector as the starting point. In this example, a stabilized treated cell state vector was reached within 26 iterations, though a total of 35 iterations were performed to confirm stabilization.

Output of step 42, as shown in Table 6, included an indication of the stabilized treated cell state vector in which PI3K, AKT, mTORRaptor, Ras, C-Raf/Raf-1, MEK1/2, ERK/MAPK, and EGFR/ErbB1 all exhibit values of −1, indicating that the cancer signaling profile was reversed. Signaling via EGFR/ErbB1 was found to be inhibited. The value for apoptosis was 1, indicating that apoptosis was re-established. The value for remission was 1, indicating that stable remission is possible when an EGFR inhibitor is administered to a patient exhibiting this gene mutation profile. Therefore, no other treatment options were evaluated for this gene profile.

Since one of the standard treatments for KRAS wild type (non-mutant) colorectal cancer is to administer Erbitux®, an EGFR inhibitor, the predictions of the FCM simulation are borne out by clinical results in human treatment.

TABLE 6

| | | Treated cell state |
|---|---|---|
| | Diseased cell state | vector values after |
| | vector values | EGFR inhibitor |
| PI3K | 1 | −1 |
| AKT | 1 | −1 |
| mTORRaptor | 1 | −1 |
| Ras | 1 | −1 |
| C-Raf/Raf-1 | 1 | −1 |
| MEK1/2 | 1 | −1 |
| ERK/MAPK | 1 | −1 |
| EGFR/ErbB1 | 1 | −1 |
| Apoptosis | −1 | 1 |
| Remission possible | −1 | 1 |

### Example 7

### In Vivo Results for Database Augmentation

A patient biopsy is obtained from a cancerous tumor and the biopsy is analyzed for its genetic profile. Cancerous genes are used to transfect a xenograft tumor posted by a suitable rodent species, such as a particular mouse species. Once the tumors reach appreciable size, a treatment regimen suggested by the FCM model based on historical results for the gene profile obtained from the medical literature. The efficacy of the treatment suggested by the model is determined following an appropriate treatment time. Efficacy may be evaluated by comparing a number of available parameters, such as tumor size, rodent weight gain or loss, rodent behavior, or rodent survival. These parameters are measured and used to determine efficacy of the treatment proposed by the FCM model. One potential efficacy parameter may be whether or not the treatment option suggested by the FCM model results in stable remission of the xenograft tumor. Another parameter may be dose dependence of the suggested treatment. The results are placed in a database and cross-correlated with the genetic profile obtained from the patient biopsy. The results may be cross-correlated with available historical medical literature results. Optionally, the results may be cross-correlated along with real patient data relating to at least the likelihood of stable remission obtained using the proposed treatment.

The above example simulations were conducted for the gene mutation profiles identified, and different gene mutation profiles would likely produce different results.

While the foregoing provides certain non-limiting example embodiments, it should be understood that combinations, subsets, and variations of the foregoing are contemplated. The monopoly sought is defined by the claims.

What is claimed is:

1. A computer-implemented method of modeling a cell state, the method comprising:
modeling at least a portion of a healthy cell using a cell model based on a fuzzy cognitive map, the cell model defining relationships between factors, the cell model being stored in at least a computer;
applying a disease state vector to the cell model, the disease state vector configured to represent a disease affecting the cell;
obtaining a diseased cell state vector of the cell model based on the applied disease state vector; and
providing a first output indicative of the diseased cell state vector of the cell model.

2. The method of claim 1, further comprising receiving an indication of the disease state vector via a network connected to the at least one computer.

3. The method of claim 1, further comprising sending the first output over a network connected to the at least one computer.

4. The method of claim 1, wherein the disease state vector is applied as a policy to the cell model over a series of iteratively applied state vectors to obtain the diseased cell state vector.

5. The method of claim 4, further comprising selecting a stabilized state vector as the diseased cell state vector.

6. The method of claim 1, wherein the disease state vector is based on a genetic profile of a tumor.

7. The method of claim 1, wherein the disease state vector represents a genetic mutation of the cell.

8. The method of claim 1, wherein the disease state vector represents an effect of a cancer.

9. The method of claim 1, wherein the cell model comprises a matrix and applying the disease state vector to the cell model includes multiplying the matrix by disease state vectors in an iterative manner to obtain a stable diseased cell state vector.

10. The method of claim 1, further comprising:
modifying the diseased cell state vector to obtain a treatment state vector configured to represent a proposed treatment for the disease;
applying the treatment state vector to the cell model;
obtaining a treated cell state vector of the cell model based on the applied treatment state vector; and
providing a second output indicative of the treated cell state vector of the cell model.

11. The method of claim 10, further comprising receiving an indication of the treatment state vector via a network connected to the at least one computer.

12. The method of claim 10, wherein the second output is indicative of an efficacy of the proposed treatment.

13. The method of claim 10, further comprising sending the second output over a network connected to the at least one computer.

14. The method of claim 10, wherein the treatment state vector represents administration of one or more of a drug, radiation therapy, immunotherapy, or hormonal therapy directed to at least one cell signaling process or pathway.

15. The method of claim 10, wherein the treatment state vector is applied as a policy to the cell model over a series of iteratively applied state vectors to obtain the treated cell state vector.

16. The method of claim 15, further comprising selecting a stabilized state vector as the treated cell state vector.

17. The method of claim 10, wherein the cell model comprises a matrix and applying the treatment state vector to the cell model includes multiplying the matrix by treatment state vectors in an iterative manner to obtain a stable treated cell state vector.

18. The method of claim 1, wherein the cell model represents at least a cell signaling pathway.

19. The method of claim 18, wherein the cell model is based at least in part on empirical data of the cell signaling pathway.

20. The method of claim 18, wherein the disease state vector is configured to represent a disease affecting the cell signaling pathway.

21. The method of claim 1, wherein the first output indicates the state of a marker gene.

22. The method of claim 1, wherein the cell model is based on a trivalent-state or pentavalent-state fuzzy cognitive map.

23. The method of claim 1, wherein the cell model is based on a continuous-state fuzzy cognitive map.

24-53. (canceled)
